(19) United States
(12) Patent Application Publication
(10) Pub. No.: US 2026/0089136 A1
(43) Pub. Date: Mar. 26, 2026

(54) FIREWALL PROTECTION WITH MANAGED DETECTION AND RESPONSE INTEGRATION

(71) Applicant: Sophos Limited, Abingdon (GB)

(72) Inventors: Nishit Shantibhai Shah, Ahmedabad (IN); Jimit Hareshkumar Mahadevia, Ahmedabad (IN); Santoshkumar Mankar, Kalaburagi (IN); Amulya Kumar Mishra, Bangalore (IN); Parth Mistry, Ahmedabad (IN); Nilesh Kanaiyalal Patel, Cranberry Twp, PA (US); Sanketkumar Maheshkumar Shah, Ahmedabad (IN); Andrew J. Thomas, Long Wittenham (GB)

(21) Appl. No.: 19/095,424

(22) Filed: Mar. 31, 2025

(30) Foreign Application Priority Data
Sep. 25, 2024 (IN) 202411072456

(51) Int. Cl. H04L 9/40

(52) U.S. Cl. CPC H04L 63/02; H04L 63/1416

(57) ABSTRACT

A method for responding to a threat includes identifying, by a managed or extended detection and response system, a threat associated with a monitored network system, sending, by the managed or extended detection and response system, threat information associated with the threat to a firewall of the monitored network system, and automatically responding, by the firewall of the monitored network system, to the sent threat information.

### CROSS-REFERENCE TO RELATED APPLICATION

This application claims priority under 35 U.S.C. § 119 from Indian Provisional Patent Application No. 202411072456 filed on Sep. 25, 2024 entitled “FIREWALL PROECTION WITH MANAGED DETECTION AND RESPONSE INTEGRATION” the entire contents of which are hereby incorporated by reference.

### FIELD

The present disclosure relates generally to firewall cyber security, and more particularly, active threat protection and automatic threat responses in firewalls of monitored network systems.

### BACKGROUND

From the discovery of the Morris Worm, the first known malware to today's complex, multi-stage attacks, the malicious actors continue to evolve and innovate their tactics, forcing the cybersecurity community to try to stay ahead with anti-malware solutions that will catch the new behaviors in the act before data can be exfiltrated, ransom demands can be made or a breach is successful. The cybersecurity industry began with the notion of prevention but has moved far away from that initial goal and now has an almost entirely reactive posture. The industry focus is more towards investment in detection and response which has come in the form of endpoint detection and response (EDR), network detection and response (NDR), managed detection and response (MDR), and extended detection and response (XDR).

Thus, individuals or organizations are now subject to an increasing number of security risks. The majority of those risks come from when an unknown domain or ip address is accessed by a user, thereby subjecting the user device to phishing, malware, or the like. To mitigate these problems, there are numerous third-party sources that provide a stream of known or suspected malicious hosts, either by domain name or by IP address. In some cases, this data may be created internally or by third-party software and services. Moreover, when managed detection and response (MDR) systems detect suspicious domains, IP addresses, URLs or the like, an MDR analyst needs to be able to respond to apply configurations on a firewall to protect from known indicators of compromise (IOCs).

As such, systems and methods for enhancing detection and response to malicious actors in a firewall system of a monitored network, would be well received in the art.

### SUMMARY

According to embodiments, disclosed herein is a method and associated computer system and computer program product for responding to a threat. A managed or extended detection and response system identifies a threat associated with a monitored network system. The managed or extended detection and response system sends threat information associated with the threat to a firewall of the monitored network system. The firewall of the monitored network system automatically responds to the sent threat information.

In other embodiments, a threat management computer system, includes one or more processors; one or more computer readable storage media; and computer readable code stored collectively in the one or more computer readable storage media, with the computer readable code including data and instructions to cause the one or more computer processors to perform a method for responding to a threat. The method includes identifying, by a managed or extended detection and response system of the threat management computer system, a threat associated with a monitored network system of the threat management computer system; sending directly or indirectly, by the managed or extended detection and response system, threat information associated with the threat to a firewall of the monitored network system; and automatically responding, by the firewall of the monitored network system, to the sent threat information.

In other embodiments, a computer program product includes one or more computer readable storage media having computer readable program code collectively stored on the one or more computer readable storage media, the computer readable program code being executed by one or more processors of a threat management computer system to cause the threat management computer system to perform a method for responding to a threat. The method includes identifying, by a managed or extended detection and response system, a threat associated with a monitored network system; sending directly or indirectly, by the managed or extended detection and response system, threat information associated with the threat to a firewall of the monitored network system; and automatically responding, by the firewall of the monitored network system, to the sent threat information.

In other embodiments, a method for responding to a threat includes identifying, by a managed or extended detection and response system, a threat associated with a monitored network system; sending, by the managed or extended detection and response system, threat information associated with the threat to a central threat management facility system; receiving, by the central threat management facility system, the threat information associated with the threat from the managed or extended detection and response system; pushing, by the central threat management facility system using an application programming interface (API), the threat information associated with the threat to a firewall of the monitored network system; determining, by the firewall of the monitored network system, a malicious host associated with an indicator of compromise including automatically performing, by the firewall, an MDR or XDR lookup with an indicator of compromise database based on an internet protocol (IP) address type indicator of compromise against source and/or destination IP addresses; and automatically initiating, by the firewall of the monitored network system, an active threat response to automatically isolate the malicious host across the monitored network system.

### BRIEF DESCRIPTION OF THE DRAWINGS

The above and further advantages of this disclosure may be better understood by referring to the following description in conjunction with the accompanying drawings, in which like reference numerals indicate like elements and features in the various figures. For clarity, not every element may be labeled in every figure. The drawings are not necessarily to scale, emphasis instead being placed upon illustrating the principles of the disclosure.

FIG. 1 depicts a block diagram of an environment for threat management, according to an example embodiment.

FIG. 2 depicts an architectural schematic view of a central threat management system connected to a firewall system, according to an example embodiment.

FIG. 3 depicts another architectural schematic view of a central threat management system connected to a firewall system, according to an example embodiment.

FIG. 4 depicts an architectural schematic view of a firewall system in communication with managed endpoints, according to an example embodiment.

FIG. 5 depicts a flow chart for performing a lookup by a consumer, according to an example embodiment.

FIG. 6 depicts a sequence flow for performing a lookup, according to an example embodiment.

FIG. 7 depicts an alternative embodiment using a hash table Deamon, according to an example embodiment.

FIG. 8 depicts an architectural schematic view of an MDR system connected to a central threat management system which is further connected to a firewall system, according to an example embodiment.

FIG. 9 depicts an architectural schematic view of the central threat management system of FIG. 8 performing an API request execution, according to an example embodiment.

FIG. 10 depicts an architectural schematic view of the central threat management system of FIG. 8 receiving the results of the API request execution from a user interface, according to an example embodiment.

FIG. 11 depicts a sequence flow for performing an API request, according to an example embodiment.

FIG. 12 depicts a sequence flow for performing receiving the results of the API request execution, according to an example embodiment.

FIG. 13 an architectural schematic view of a central threat management system connected to a firewall system, according to an example embodiment.

FIG. 14 depicts an architectural schematic view of a firewall system connected to a graphical user interface (GUI), according to an example embodiment.

FIG. 15 depicts an architectural schematic view of a containerized service request processing flow for a firewall, according to an example embodiment.

FIG. 16 depicts a flow chart for performing a third party threat feed lookup by a consumer, according to an example embodiment.

FIG. 17 depicts an architectural schematic view of a firewall system connected to a threat management system, according to an example embodiment.

FIG. 18 depicts an architectural schematic view of a risk storage system connected to producer and consumer systems, according to an example embodiment.

FIG. 19 depicts a diagram of an example computing device, according to an example embodiment.

### DETAILED DESCRIPTION

Reference in the specification to “one embodiment” or “an embodiment” means that a particular, feature, structure or characteristic described in connection with the embodiment is included in at least one embodiment of the teaching. References to a particular embodiment within the specification do not necessarily all refer to the same embodiment.

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill having access to the teaching herein will recognize additional implementations, modifications and embodiments, as well as other fields of use, which are within the scope of the present disclosure as described herein.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “approximately” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms.

It should also be understood that endpoints, devices, compute instances or the like that are referred to as “within” an enterprise network may also be “associated with” the enterprise network, e.g., where such assets are outside an enterprise gateway but nonetheless managed by or in communication with a threat management facility or other centralized security platform for the enterprise network. Thus, any description referring to an asset within the enterprise network should be understood to contemplate a similar asset associated with the enterprise network regardless of location in a network environment unless a different meaning is explicitly provided or otherwise clear from the context.

Embodiments herein are directed to methods and computer systems configured to respond to a threat in the cyber security context with endpoint (i.e. host, device and/or user) isolation. As contemplated herein, computers, and their central management system, upon detecting or otherwise receiving information indicating a threat to an endpoint, may perform a global isolation of the endpoint across various network devices and/or products within the network to block a device identifier or user identification associated with the endpoint that is responsible for the threat.

The present disclosure endeavors to mitigate the problems associated with digital security threats such as phishing, malware and the like. To mitigate these problems, the present disclosure recognizes that there are numerous third-party sources that provide a stream of known or suspected malicious hosts, either by domain name or by IP address. In some cases, this data may be created internally or by third-party software and services. This present disclosure seeks to integrate and apply applies this threat intelligence in firewall systems to protect customer traffic.

Further, when a managed detection and response (MDR) system detects suspicious IP addresses, domains, URLs or the like, the present disclosure recognizes that an MDR analyst needs to be able to apply a threat feed configuration on a firewall to protect from known incidents of compromise (IOCs). To accomplish this, the present disclosure contemplates the MDR system calling a central threat management facility system threat feed APIs, which may be executed in two steps (asynchronous APIs): 1) the MDR system sends the API request to the central threat management facility system using a secured service access (SSA) system, whereby the central threat management facility sends back a response (including a unique job ID for an API call) to the MDR system after successfully generating a configuration to be applied on a firewall system; and 2) the MDR system should use the job ID for polling execution results of the API called in the first step.

Still further, the present disclosure recognizes that for all incoming traffic on a firewall system, both an MDR system and an internal scanning system of the central threat management facility system may be used in order to scan for malicious requests based on IOCs. However, customers and clients who are being managed by the central threat management facility system may also wish to add their own IOCs, or those from additional third party systems, to protect their network. In this way, an administrator for a customer or client may configure a third party threat feed with different polling intervals and with actions to monitor and/or block traffic. Thus, the present disclosure contemplates providing customers or clients of a central threat management facility system to protect against IOCs and other threats identified by an external third party entity.

Moreover, the present disclosure seeks to incorporate the advancements in artificial intelligence (AI) in the form of machine learning (ML) in order to automate processes to get ahead of an attacker's tactics. For example, network detection and response (NDR) integration with firewall systems described herein may provide for advanced protection capability using ML detection models provided by an NDR system. This may allow managed clients or customers to be protected from zero-day threats and in general provide for staying ahead of malicious attacks.

Overall, the concepts described herein provide for a firewall system which can be updated to not only detect threats, but also block and monitor threats. In order to accomplish this, the present disclosure seeks to implement changes in firewall systems deployed at managed customer systems, as well as changes done at the central threat management facility system.

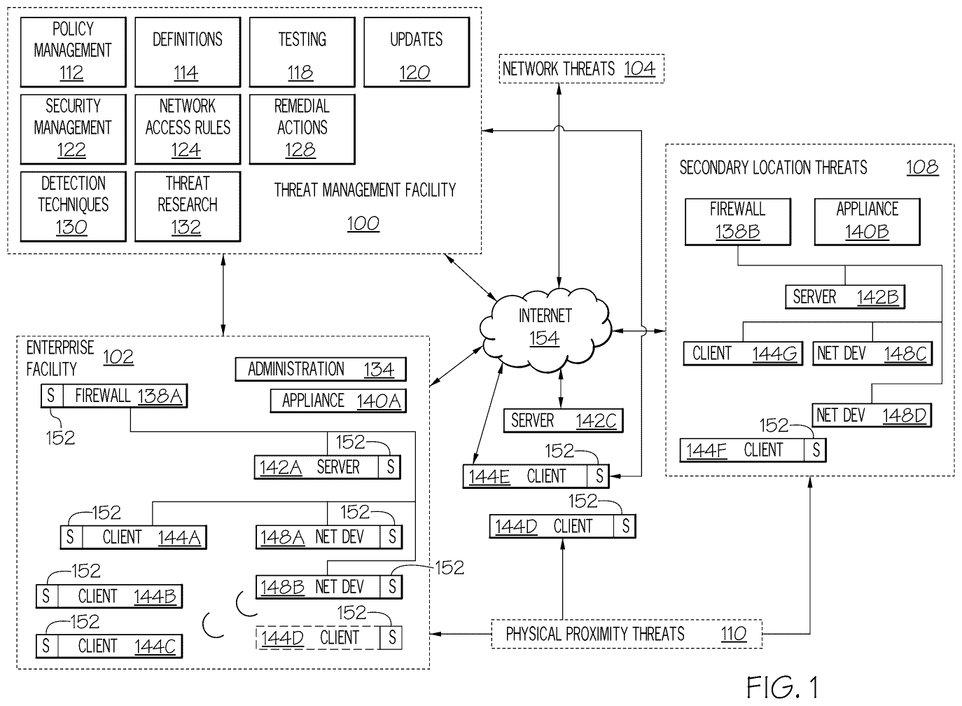

FIG. 1 illustrates an environment for threat management, according to an example embodiment. Specifically, FIG. 1 depicts a block diagram of a threat management facility 100 providing protection to one or more enterprises, networks, locations, users, businesses, etc. against a variety of threats—a context in which the techniques described herein may usefully be deployed. The threat management facility 100 may represent any the threat management system, such as the threat management systems described herein below.

The threat management facility 100 may be used to protect devices and assets (e.g., IoT devices or other devices) from computer-generated and human-generated threats. For example, a corporation, school, web site, homeowner, network administrator, or other entity may institute and enforce one or more policies that control or prevents certain network users (e.g., employees, residents, users, guests, etc.) from accessing certain types of applications, devices, resources generally or in a particular manner. Policies may be created, deployed and managed, for example, through the threat management facility 100, which may update and monitor network devices, users, and assets accordingly.

The threat of enumeration attacks, malware or other compromises may be present at various points within a network 102 such as laptops, desktops, servers, gateways, communication ports, handheld or mobile devices, IoT devices, firewalls. In addition to controlling or stopping malicious code, a threat management facility 100 may provide policy management to control devices, applications, or users that might otherwise undermine productivity and network performance within the network 102.

The threat management facility 100 may provide protection to network 102 from computer-based malware, including viruses, spyware, adware, Trojans, intrusion, spam, policy abuse, advanced persistent threats, uncontrolled access, and the like. In general, the network 102 may be any networked computer-based infrastructure or the like managed by a threat management facility 100, such as an organization, association, institution, or the like, or a cloud-based facility that is available for subscription by individuals. For example, the network 102 may be a corporate, commercial, educational, governmental, or other network 102, and may include multiple networks, computing resources, and other facilities, may be distributed among more than one geographical location, and may include administration 134, a firewall 138A, an appliance 140A, a server 142A, network devices 148A-B, clients 144A-D, such as IoT devices or other devices. It will be understood that any reference herein to a client or client facilities may include the clients 144A-D shown in FIG. 1 and vice versa.

The threat management facility 100 may include computers, software, or other computing facilities supporting a plurality of functions, such as security management facility 122, policy management facility 112, update facility 120, a definitions facility 114, network access rules facility 124, remedial action facility 128, detection techniques facility 130, testing facility 118, a threat research facility 132, and the like. In embodiments, the threat protection provided by the threat management facility 100 may extend beyond the network boundaries of the network 102 to include clients 144D (or client facilities) that have moved into network connectivity not directly associated with or controlled by the network 102. Threats to client facilities may come from a variety of sources, such as from network threats 104, physical proximity threats 110, secondary location threats 108, and the like. Clients 144A-D may be protected from threats even when the client 144A-D is not directly connected or in association with the network 102, such as when a client 144E-F moves in and out of the network 102, for example when interfacing with an unprotected server 142C through the Internet 154, when a client 144F is moving into a secondary location threat 108 network such as interfacing with components 140B, 142B, 148C, 148D that are not protected, and the like.

The threat management facility 100 may use or may be included in an integrated system approach to provide network 102 protection from a plurality of threats to device resources in a plurality of locations and network configurations. The threat management facility 100 may also or instead be deployed as a stand-alone solution. For example, some or all of the threat management facility 100 components may be integrated into a server or servers at a remote location, for example in a cloud computing facility. For example, some or all of the threat management facility 100 components may be integrated into a firewall, gateway, or access point within or at the border of the network 102. In some embodiments, the threat management facility 100 may be integrated into a product, such as a third-party product, e.g., through an application programming interface, which may be deployed on endpoints, on remote servers, on internal servers or gateways for a network, or some combination of these.

The security management facility 122 may include a plurality of elements that provide protection from malware to network 102 device resources in a variety of ways including endpoint security and control, email security and control, web security and control, reputation-based filtering, control of unauthorized users, control of guest and non-compliant computers, and the like. The security management facility 122 may include a local software application that provides protection to one or more network 10 devices. The security management facility 122 may have the ability to scan client facility files for malicious code, remove or quarantine certain applications and files, prevent certain actions, perform remedial actions and perform other security measures. This may include scanning some or all of the files stored on the client facility or accessed by the client facility on a periodic basis, scanning an application when the application is executed, scanning data (e.g., files or other communication) in transit to or from a device, etc. The scanning of applications and files may be performed to detect known or unknown malicious code or unwanted applications.

The security management facility 122 may provide email security and control. The security management facility 122 may also or instead provide for web security and control, such as by helping to detect or block viruses, spyware, malware, unwanted applications, and the like, or by helping to control web browsing activity originating from client devices. In an embodiment, the security management facility 122 may provide for network access control, which may provide control over network connections. In addition, network access control may control access to virtual private networks (VPN) that provide communications networks tunneled through other networks. The security management facility 122 may provide host intrusion prevention through behavioral based protection, which may guard against known or unknown threats by analyzing behavior before or while code executes. The security management facility 122 may provide reputation filtering, which may target or identify sources of code.

In general, the security management facility 122 may support overall security of the network 102 using the various techniques described above, optionally as supplemented by updates of malicious code information and so forth for distribution across the network 102.

The administration facility 134 may provide control over the security management facility 122 when updates are performed. Information from the security management facility 122 may also be sent from the enterprise back to a third party, a vendor, or the like, which may lead to improved performance of the threat management facility 100.

The threat management facility 100 may include a policy management facility 112 configured to take actions, such as to block applications, users, communications, devices, and so on based on determinations made. The policy management facility 112 may employ a set of rules or policies that determine network 102 access permissions for a client 144. In an embodiment, a policy database may include a block list, a blacklist, an allowed list, a whitelist, or the like, or combinations of the foregoing, that may provide a list of resources internal or external to the network 102 that may or may not be accessed by client devices 144. The policy management facility 112 may also or instead include rule-based filtering of access requests or resource requests, or other suitable techniques for controlling access to resources consistent with a corresponding policy.

The policy management facility 112 may also provide configuration policies to be used to compare and control the configuration of applications, operating systems, hardware, devices, network associated with the network 102. An evolving threat environment may dictate timely updates, and thus an update management facility 120 may also be provided by the threat management facility 100. In addition, a policy management facility 112 may require update management (e.g., as provided by the update facility 120 herein described). In embodiments, the update management facility 120 may provide for patch management or other software updating, version control, and so forth.

The security facility 122 and policy management facility 112 may push information to the network 102 and/or a given client 144. The network 102 and/or client 144 may also or instead request information from the security facility 122 and/or policy management facility 112, network server facilities 142, or there may be a combination of pushing and pulling of information. In an embodiment, the policy management facility 112 and the security facility 122 management update modules may work in concert to provide information to the network 102 and/or client 144 facility for control of applications, devices, users, and so on.

As threats are identified and characterized, the threat management facility 100 may create updates that may be used to allow the threat management facility 100 to detect and remediate malicious software, unwanted applications, configuration and policy changes, and the like. The threat definition facility 114 may contain threat identification updates, also referred to as definition files. A definition file may be a virus identity file that may include definitions of known or potential malicious code. The virus identity definition files may provide information that may identify malicious code within files, applications, or the like. The definition files may be accessed by security management facility 122 when scanning files or applications within the client facility for the determination of malicious code that may be within the file or application. A definition management facility may include a definition for a neural network or other recognition engine. A definition management facility 114 may provide timely updates of definition files information to the network, client facilities, and the like.

The security management facility 122 may be used to scan an outgoing file and verify that the outgoing file is permitted to be transmitted per the enterprise facility 102 rules and policies. By checking outgoing files, the security management facility 122 may be able to discover malicious code infected files that were not detected as incoming files.

The threat management facility 100 may provide controlled access to the network 102. A network access rules facility 124 may be responsible for determining if a client facility 144 application should be granted access to a requested network resource. In an embodiment, the network access rules facility 124 may verify access rights for client facilities 144 to or from the network 102 or may verify access rights of computer facilities to or from external networks. When network access for a client facility is denied, the network access rules facility 124 may send an information file to the client facility, e.g., a command or command file that the remedial action facility 128 may access and take action upon. The network access rules facility 124 may include one or more databases that may include a block list, a blacklist, an allowed list, a white list, a reputation list, an unacceptable network resource database, an acceptable network resource database, a network resource reputation database, or the like. The network access rules facility 124 may incorporate rule evaluation. Rule evaluation may, for example, parse network access requests and apply the parsed information to network access rules. The network access rule facility 124 may also or instead provide updated rules and policies to the enterprise facility 102.

When a threat or policy violation is detected by the threat management facility 100, the threat management facility 100 may perform or initiate remedial action through a remedial action facility 128. Remedial action may take a variety of forms, such as terminating or modifying an ongoing process or interaction, issuing an alert, sending a warning to a client or administration facility 134 of an ongoing process or interaction, executing a program or application to remediate against a threat or violation, record interactions for subsequent evaluation, and so forth. The remedial action may include one or more of blocking some or all requests to a network location or resource, performing a malicious code scan on a device or application, performing a malicious code scan on the client facility 144, quarantining a related application (or files, processes or the like), terminating the application or device, isolating the application or device, moving a process or application code to a sandbox for evaluation, isolating the client facility 144 to a location or status within the network that restricts network access, blocking a network access port from a client facility 144, reporting the application to an administration facility 134, or the like, as well as any combination of the foregoing.

Remedial action may be provided as a result of a detection of a threat or violation. The detection techniques facility 130 may include tools for monitoring the network or managed devices within the network 102. The detection techniques facility 130 may provide functions such as monitoring activity and stored files on computing facilities. Detection techniques, such as scanning a computer's stored files, may provide the capability of checking files for stored threats, either in the active or passive state. Detection techniques such as streaming file management may be used to check files received at the network, a gateway facility, a client facility, and the like.

Verifying that the threat management facility 100 detects threats and violations to established policy, may require the ability to test the system, either at the system level or for a particular computing component. The testing facility 118 may allow the administration facility 134 to coordinate the testing of the security configurations of client facility computing facilities on a network. For example, the administration facility 134 may be able to send test files to a set of client facility computing facilities to test the ability of the client facility to determine acceptability of the test file. After the test file has been transmitted, a recording facility may record the actions taken by the client facility in reaction to the test file. The recording facility may aggregate the testing information from the client facility and report the testing information to the administration facility 134. The administration facility 134 may be able to determine the level of preparedness of the client facility 144 based on the reported information. Remedial action may be taken for any of the client facilities 144 as determined by the administration facility 134.

The threat management facility 100 may provide threat protection across the network 102 to devices such as clients 144, a server facility 142, an administration facility 134, a firewall 138, a gateway, one or more network devices (e.g., hubs and routers 148, a threat management or other appliance 140, any number of desktop or mobile users, and the like. As used herein the term endpoint may refer to any compute instance running on a device that can source data, receive data, evaluate data, buffer data, process data or the like (such as a user's desktop computer, laptop, IoT device, server, etc.). This may, for example, include any client devices as well as other network devices and the like within the network 102, such as a firewall or gateway (as a data evaluation endpoint computer system), a laptop (as a mobile endpoint computer), a tablet (as a hand-held endpoint computer), a mobile phone, or the like. The term endpoint may also or instead refer to any final or intermediate source or destination for data within a network 102. The endpoint computer security facility 152 may be an application locally loaded onto any corresponding computer platform or computer support component, either for local security functions or for management by the threat management facility 100 or other remote resource, or any combination of these.

The network 102 may include a plurality of client facility computing platforms on which the endpoint computer security facility 152 is installed. A client facility computing platform may be a computer system that is able to access a service on another computer, such as a server facility 142, via a network. The endpoint computer security facility 152 may, in corresponding fashion, provide security in any suitable context such as among a plurality of networked applications, for a client facility connecting to an application server facility 142, for a web browser client facility connecting to a web server facility 142, for an e-mail client facility retrieving e-mail from an Internet 154 service provider's mail storage servers 142 or web site, and the like, as well as any variations or combinations of the foregoing.

The network 102 may include one or more of a variety of server facilities 142, such as application servers, communications servers, file servers, database servers, proxy servers, mail servers, fax servers, game servers, web servers, and the like. A server facility 142, which may also be referred to as a server facility 142 application, server facility 142 operating system, server facility 142 computer, or the like, may be any device(s), application program(s), operating system(s), or combination of the foregoing that accepts client facility connections in order to service requests from clients 144. In embodiments, the threat management facility 100 may provide threat protection to server facilities 142 within the network 102 as load conditions and application changes are made.

A server facility 142 may include an appliance facility 140, where the appliance facility 140 provides specific services to other devices on the network. Simple server facility 142 appliances may also be utilized across the network 102 infrastructure, such as switches, routers, hubs, gateways, print servers, modems, and the like. These appliances may provide interconnection services within the network 102, and therefore may advance the spread of a threat if not properly protected.

A client facility 144 may be protected from threats from within the network 102 using a local or personal firewall, which may be a hardware firewall, software firewall, or combination, that controls network traffic to and from a client. The local firewall may permit or deny communications based on a security policy. Another component that may be protected by an endpoint computer security facility 152 is a network firewall facility 138, which may include hardware or software, in a standalone device or integrated with another network component, that may be configured to permit, deny, or proxy data through a network 102.

The interface between the threat management facility 100 and the network 102, and through the appliance facility 140 to embedded endpoint computer security facilities, may include a set of tools that may be the same or different for various implementations, and may allow each network administrator to implement custom controls. In embodiments, these controls may include both automatic actions and managed actions. The administration facility 134 may configure policy rules that determine interactions. The administration facility 134 may also establish license management, which in turn may further determine interactions associated with licensed applications. In embodiments, interactions between the threat management facility 100 and the network 102 may provide threat protection to the network 102 by managing the flow of network data into and out of the network 102 through automatic actions that may be configured by the threat management facility 100 for example by action or configuration of the administration facility 134.

Client facilities 144 within the network 102 may be connected to the network 102 by way of wired network facilities 148A or wireless network facilities 148B. Mobile wireless facility clients 144, because of their ability to connect to a wireless network access point, may connect to the Internet 154 outside the physical boundary of the network 102, and therefore outside the threat-protected environment of the network 102. Such a client 144, if not for the presence of a locally installed endpoint computer security facility 152, may be exposed to a malware attack or perform actions counter to network 102 policies. Thus, the endpoint computer security facility 152 may provide local protection against various threats and policy violations. The threat management facility 100 may also or instead be configured to protect the out-of-enterprise facility 102 mobile client facility (e.g., the clients 144) through interactions over the Internet 154 (or other network) with the locally installed endpoint computer security facility 152. Thus, mobile client facilities that are components of the network 102 but temporarily outside connectivity with the network 102 may be provided with the threat protection and policy control the same as or similar to client facilities 144 inside the network 102. In addition, mobile client facilities 144 may receive the same interactions to and from the threat management facility 100 as client facilities 144 inside the enterprise facility 102, such as by receiving the same or equivalent services via an embedded endpoint computer security facility 152.

Interactions between the threat management facility 100 and the components of the network 102, including mobile client facility extensions of the network 102, may ultimately be connected through the Internet 154 or any other network or combination of networks. Security-related or policy-related downloads and upgrades to the network 102 may be passed from the threat management facility 100 through to components of the network 102 equipped with the endpoint computer security facility 152. In turn, the endpoint computer security facility 152 components of the enterprise facility or network 102 may upload policy and access requests back across the Internet 154 and through to the threat management facility 100. The Internet 154 however, is also the path through which threats may be transmitted from their source, and an endpoint computer security facility 152 may be configured to protect a device outside the network 102 through locally deployed protective measures and through suitable interactions with the threat management facility 100.

Thus, if the mobile client facility were to attempt to connect into an unprotected connection point, such as at a secondary location 108 that is not a part of the network 102, the mobile client facility 144 may be required to request network interactions through the threat management facility 100, where contacting the threat management facility 100 may be performed prior to any other network action. In embodiments, the client facility's 144 endpoint computer security facility 152 may manage actions in unprotected network environments such as when the client facility (e.g., client 144F) is in a secondary location 108, where the endpoint computer security facility 152 may dictate what applications, actions, resources, users, etc. are allowed, blocked, modified, or the like.

The secondary location 108 may have no endpoint computer security facilities 152 as a part of its components, such as its firewalls 138B, servers 142B, clients 144G, hubs and routers 148C-D, and the like. As a result, the components of the secondary location 108 may be open to threat attacks, and become potential sources of threats, as well as any mobile enterprise facility clients 144B-F that may be connected to the secondary location's 108 network. In this instance, these components may now unknowingly spread a threat to others connected to the network 102.

Some threats do not come directly from the internet 154. For example, a physical proximity threat 110 may be deployed on a client device while that device is connected to an unprotected network connection outside the enterprise facility 102, and when the device is subsequently connected to a client 144 on the network 102, the device can deploy the malware or otherwise pose a threat. In embodiments, the endpoint computer security facility 152 may protect the network 102 against these types of physical proximity threats 110, for instance, through scanning any device prior to allowing data transfers, through security validation certificates, through establishing a safe zone within the network 102 to receive data for evaluation, and the like.

Having provided an overall context for threat detection, the description now turns to a brief discussion of embodiments of the present concept, followed by a description of systems and methods for active threat response including host or endpoint isolation.

Embodiments described herein provide for methods, systems and/or computer program products for responding to a threat that include identifying, by a managed or extended detection and response system, a threat associated with a monitored network system, sending directly or indirectly (i.e. via or through a central threat management facility or system intermediary) threat information associated with the threat to a firewall of the monitored network system, and automatically responding, by the firewall of the monitored network system, to the sent threat information.

In various embodiments, the automatically responding, by the firewall of the monitored network system, includes responding without manual creation of address, domain, URL objects, web policies and/or firewall rules. Further, the sending directly or indirectly (i.e. via or through a central threat management facility or system intermediary), by the managed or extended detection and response system using the at least one application programing interface, the threat information associated with the threat to the firewall of the monitored network system. Methods may further include sending, by the managed or extended detection and response system, the threat information associated with the threat to a central threat management facility system, receiving, by the central threat management facility system, the threat information associated with the threat from the managed or extended detection and response system, and pushing, by the central threat management facility system using an application programming interface (API), the threat information associated with the threat to a firewall of the monitored network system. In some embodiments the automatically responding, by the firewall of the monitored network system, to the sent threat information, further includes automatically initiating, by the firewall of the monitored network system, lateral movement protection based on the threat to ensure that a compromised host cannot move laterally or communicate outside the monitored network system.

Still further, the automatically responding, by the firewall of the monitored network system, to the sent threat information may further include determining, by the firewall of the monitored network system, a malicious host associated with an indicator of compromise, and automatically initiating, by the firewall of the monitored network system, an active threat response to automatically isolate malicious traffic coming from the malicious host across the monitored network system.

Moreover, the determining, by the firewall of the monitored network system, the malicious host associated with the indicator of compromise may further include automatically performing, by the firewall, a threat lookup with an indicator of compromise database based on an internet protocol (IP) address type indicator of compromise against source and/or destination IP addresses and/or may further include automatically performing, by the firewall, a threat lookup with the indicator of compromise database based on an IP or domain type indicator of compromise against a DNS payload. The automatically performing, by the firewall, the threat lookup with the indicator of compromise database based on the IP or domain type indicator of compromise against the DNS payload may also include using a deep packet inspection engine and DNS server to inspect the web traffic payload, and automatically performing, by the firewall, a threat lookup with the indicator of compromise database based on the inspection of the web traffic payload by the deep packet inspection engine and the DNS server. More particular, the deep packet inspection engine (DPIE) may be configured to inspect traffic flowing through the firewall system, whereas the DNS server may be configured to inspect DNS traffic of endpoints that have configured the firewall system as a DNS server.

The determining, by the firewall of the monitored network system, the malicious host associated with the indicator of compromise may further include automatically performing, by the firewall, a threat lookup with the indicator of compromise database based on an IP, domain and/or URL type indicator of compromise against a web traffic payload. The automatically performing, by the firewall, the MDR or XDR lookup with the indicator of compromise database based on the IP, domain and/or URL type indicator of compromise against the web traffic payload may further include using the deep packet inspection engine to inspect the web traffic payload, and automatically performing, by the firewall, a threat lookup with the indicator of compromise database based on the inspection of the web traffic payload by the deep packet inspection engine.

Moreover, the automatically initiating, by the firewall of the monitored network system, the active threat response to automatically isolate the malicious host across the monitored network system may further include determining, by the firewall of the monitored network system, a policy action when any of the threat lookups are positive, and logging the event in an event log system or dropping the traffic and logging the event in the event log system based on the determining. The logging the event in the event log system or dropping the traffic and logging the event in the event log system based on the determining may further include querying, by the firewall of the monitored network system, managed endpoints of the monitored network system for information including executable path, logged-in user, process user, process hash, endpoint UUID and/or process identifier and/or logging this information.

In various embodiments, the indicator of compromise database is a shared memory hash table library located on each firewall in the firewall system.

Moreover, in various embodiments, methods may include using, by a heartbeat agent running on the firewall, a heartbeat microservice of the central threat management facility system for informing the firewall of pending API requests from the central threat management facility. Methods may still further include converting, by the central threat management facility system, each API call to corresponding opcodes understandable by the firewall, including generating, by the central threat management facility system, a configuration to be applied on the firewall, wherein the configuration is pushed by the API. Methods may further include providing, by the central threat management facility system, a threat feed user interface that is displayed and to administrators of the monitored network, and enabling the administrators of the monitored network to provide an automatic response action to threats through the threat feed user interface so that the automatic responding, by the firewall of the monitored network system, to the sent threat information is conducted in accordance with the automatic response action.

Methods, systems and/or computer program products may further include, for example, identifying, by a managed or extended detection and response system, a threat associated with a monitored network system, sending, by the managed or extended detection and response system, threat information associated with the threat to a central threat management facility system, receiving, by the central threat management facility system, the threat information associated with the threat from the managed or extended detection and response system, pushing, by the central threat management facility system using an application programming interface (API), the threat information associated with the threat to a firewall of the monitored network system, determining, by the firewall of the monitored network system, a malicious host associated with an indicator of compromise including automatically performing, by the firewall, an MDR or XDR lookup with an indicator of compromise database based on an internet protocol (IP) address type indicator of compromise against source and/or destination IP addresses, and automatically initiating, by the firewall of the monitored network system, an active threat response to automatically isolate the malicious host across the monitored network system.

Applications of the embodiments described in the present disclosure improve the functionality of an MDR analyst, by allowing an MDR analyst to block suspicious IP/Domain/URLs to protect MDR customers from known IOCs (indicator of compromise), enable or disable MDR threat protection on an MDR customer or client's firewall system, define traffic verdict as “log only” or “log and drop” for IOCs matched by MDR threat protection, and search if a set of IOCs are configured on a firewall system or not.

Moreover, applications of the embodiments described in the present disclosure improve the functionality of a firewall administrator, by allowing a firewall administrator to enable or disable MDR threat protection, define traffic verdict as “log only” or “log and drop” for IOCs matched by MDR threat protection, bypass certain network segments from MDR protection, add IP/Domain addresses as threat exception to avoid false positives and prevent unnecessary blocks, and have visibility over IoCs identified by MDR in control center, Log viewer and reports(local, central).

Still further, applications of the embodiments described in the present disclosure improve the functionality of an administrator of a central threat management facility system overseeing a variety of customer or client networks (e.g. in a cloud-based central implementation), by allowing such an administrator to perform various operations at appliance or group level, such as enabling or disabling MDR threat protection, defining traffic verdict as “log only” or “log and drop” for IOCs matched by MDR threat protection, bypassing certain network segment from MDR protection, adding IP/Domain addresses as threat exception to avoid false positives and prevent unnecessary blocks, and allowing observability of API calls being performed by MDR analysts.

Present implementations protect customer or client systems against the threats identified by MDR threat feeds, provide for minimalistic enable/disable support for MDR threat feed from a user interface, provide for MDR control via a central threat management facility system, separate policy actions for “Log Only” or “Log and Drop” for MDR, and provide extra information regarding endpoint using synchronized security over heartbeat APIs. Moreover, implementations provided herein include MDR threat feeds going to a centralized threat management facility system for adaptive learning and feedback.

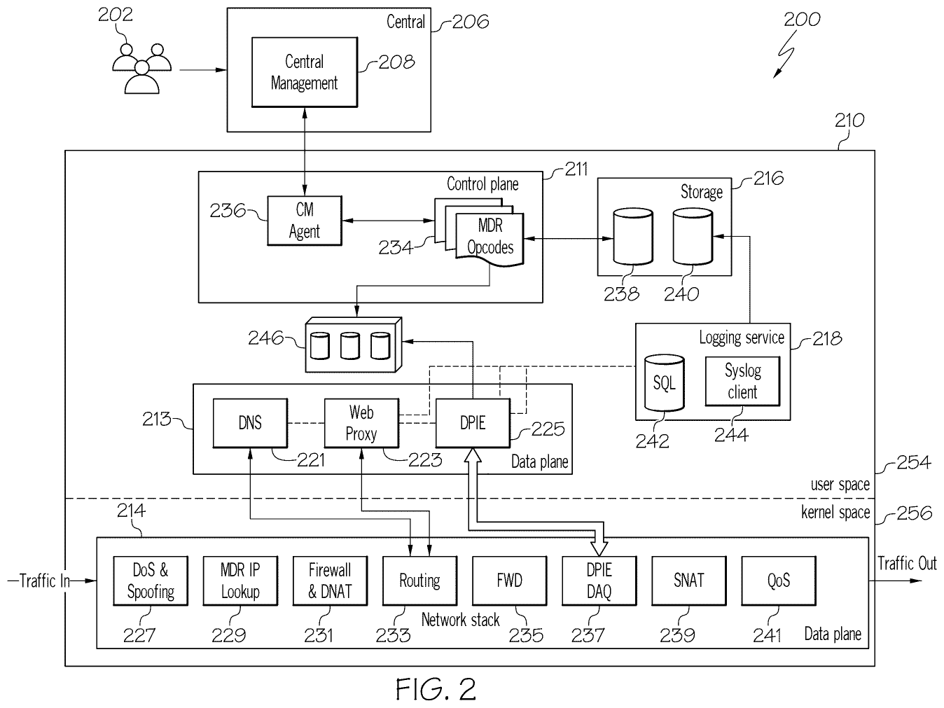

FIG. 2 depicts an architectural schematic view of a poputer system 200 having a central threat management system 206 connected to a firewall system 210, according to an example embodiment. The central threat management system 206 is connected and/or otherwise in operable communication with an MDR system and/or analyst 202. The central threat management system 206 includes a central management software system 208 configured to process information received from the MDR system 202 and communicate with the firewall system 210.

Workflows provided by the system described herein enable a web administrator user associated with a customer or client (e.g., the analyst 202, a web administrator of the central threat management system 206, or a web administrator of a monitored customer network inclusive of the firewall system 210) to be able to perform an enable or disable command for the proposed MDR response. Web administrator users may further be able to update actions to “log only” or “log and drop” for the proposed MDR response. Web administrator users may further be able to add a global network and threat exception, that may be applicable for both the proposed MDR response and active threat response (ATR). Systems provided herein may further allow a web administrator to jump to a log viewer with filters applied when performing ATR.

The firewall system 210 includes a user space 254 with at least two sections—1) a control plane 211 which is configured to handle the configuration and update of the proposed MDR IOCs; and 2) a data plane 213 which is configured to handle the IOC lookup for running traffic and apply action of “log only” or “log and drop.”

The control plane 211 includes a central management (CM) agent 236 in operable communication with the central management software system 208 using an application program interface (API) using opcode calls. The API may provide MDR threat information associated with threat information provided by the MDR system and/or analyst 202 to the central threat management system 206. MDR opcodes 234 may be stored in the control plane 211 in communication with the CM agent 236. The MDR opcodes 234 may further be in communication with an indicator of compromise database 246 that includes MDR IOCs populated in a shared memory space which also communicates with the data plane 213.

The data plane 213 includes a domain name system (DNS) service 221, a web proxy service 223 and a deep packet inspection engine (DPIE) service 225. Each of these services 221, 223, 225 may be configured to perform IOC lookups with the indicator of compromise database 246 associated with DNS traffic through the firewall system 210, web traffic through the firewall system 210, and DNS traffic inspected with DPIE through the firewall system 210.

The threat management computer system 200 further includes a storage system 216 connected to the control plane 211 including a configuration database 238 and a report database 240. The threat management computer system 200 may further include a logging service system 218 including an SQL database 242 and a syslog client 244. This logging service system 218 may be in communication with the storage system 216 and the data plane 213.

In addition, the firewall system 210 includes a kernel space 256 through which traffic is input and output. The traffic is input into a network stack 214 within the kernel space 256. The network stack 214 includes several services or APIs including a denial of service (DoS) & spoofing service 227, an MDR internet protocol (IP) lookup service 229, a firewall and a destination network address translation (DNAT) service 231, a routing service 233, a port forwarding (FWD) service 235, a DPIE data acquisition service 237, a secure network address translation (SNAT) service 239 and a quality of service (QoS) service 241.

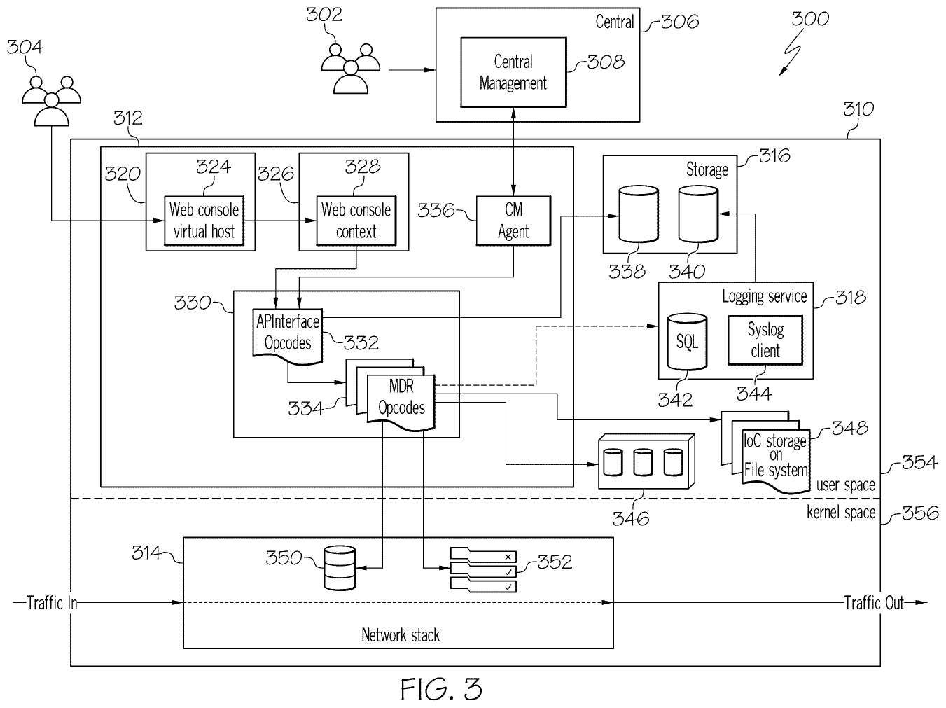

FIG. 3 depicts another architectural schematic view of a threat management computer system 300 having a central threat management system 306 connected to a firewall system 310, according to an example embodiment. The architectural schematic view of a threat management computer system 300 may be the same or similar to the architectural schematic view of the threat management computer system 200 described hereinabove. Thus, the central threat management system 306 is connected and/or otherwise in operable communication with an MDR system and/or analyst 302. The central threat management system 306 includes a central management software system 308 configured to process information received from the MDR system 302 and communicate with the firewall system 310.

However, unlike the threat management computer system 200 described hereinabove, the architectural schematic view of the threat management computer system 300 focuses on showing more specifics to a control plane 312 in a user space 354, rather than a data plane.

The control plane 312 includes a central management (CM) agent 336 in operable communication with the central management software system 308 using an application program interface (API) using opcode calls. The API may provide MDR threat information associated with threat information provided by the MDR system and/or analyst 302 to the central threat management system 306. MDR opcodes 334 may be stored in the control plane 312 in communication with the CM agent 336 via an opcode API interface 332. The MDR opcodes 334 may further be in communication with an indicator of compromise database 346 that includes MDR IOCs populated in a shared memory space. Further, the MDR opcodes 334 may be in communication with an IOC storage on file system 348.

The firewall system 310 may further be in communication with a firewall web administrator 304 and/or web administration system connected to a web server 320, such as an Apache Httpd server instance. The web server 320 may include a web console virtual host system or service 324. The web server 320 may be connected and communicate with a Java web server 326, such as an Eclipse Jetty Java web server, including a web console context system or service 328. The Java web server 326 may be in operable communication with the API interface 332. The web server 320 and the Java web server 326 may be configured to allow the firewall web administrator 304 to direct or set up automatic firewall responses to threats provided by the MDR system and/or analyst 302.

The threat management computer system 300 further includes a storage system 316 connected to the control plane 311 including a configuration database 338 and a report database 340. The threat management computer system 300 may further include a logging service system 318 including an SQL database 342 and a syslog client 344. This logging service system 318 may be in communication with the storage system 316.

In addition, the firewall system 310 includes a kernel space 356 through which traffic is input and output. The traffic is input into a network stack 314 within the kernel space 356. The network stack 314 may include several services or APIs (similar to the network stack 214 of FIG. 2), but is generally shown with an MDR IPset data storage location 350 and MDR rules system 352.

The MDR architecture objects may be created at the time of migration or factory reset of the firewall systems contemplated herein. Moreover, to update an object, an MDR configuration update process is contemplated. First, when the MDR response is enabled, this will trigger the config and parser service block to parse the threat feed file, create IPset and IPtables chains and reload threat data via the MDR engine to be consumed by other services. When the MDR response is disabled, this will trigger the config and parser service block to remove IPset and IPtables chains and then notify the MDR engine to destroy the threat feed data. Updating the network will trigger the threat protection and the MDR config and parser service block to parse the threat feed file, create IPset and IPtables chains and reload threat data via Xstream MDR engine to be consumed by other services. Updating the policy action to “log only” or “log and drop” triggers the threat protection and the MDR config and parser service block to parse the threat feed file, update IPtables chains and reload threat data via the MDR engine to be consumed by other services.

Updating the MDR system with new IOCs will include the central management (CM) agent calling an API Interface opcode with a respective mode value to update the MDR IOCs. An API Interface will update the database, if there are any config changes and will pass the request to config/parser service block. Config/parser service block will maintain all the MDR IOCs in a JSON file format, and that will be stored in/conf partition Sample JSON File.

“Config/parser service block” includes two stages. In the config stage, the MDR system will impose a limit on max number of allowed IOCs. If limit is reached, an error response will be sent to caller. The MDR system will check for mandatory persona field when an API is called by the CM agent. The MDR system will update the JSON file by adding/removing IOCs as per request, and post that it will pass the control to the parser service block. During the parser stage, the MDR system will read the JSON input file and will mark status (Exception, Invalid, Valid) for all the IOCs in the JSON file. The MDR system will

The MDR system will update “last_updated_time”, “ip_count”, “domain_count”, “last_updated_by” and “url_count” in the database for the MDR system and create IPset and add IPtables chains (as per policy action of “log only” or “log and drop”) to be consume by firewall system and/or service. For all other services (ips, web-proxy, dns), the MDR system will pass the JSON file to the MDR engine to update IOCs in a shared memory. At any point of failure, error message may be logged. Moreover, the MDR system will add “persona” and status in event log for end-to-end audit and accountability.

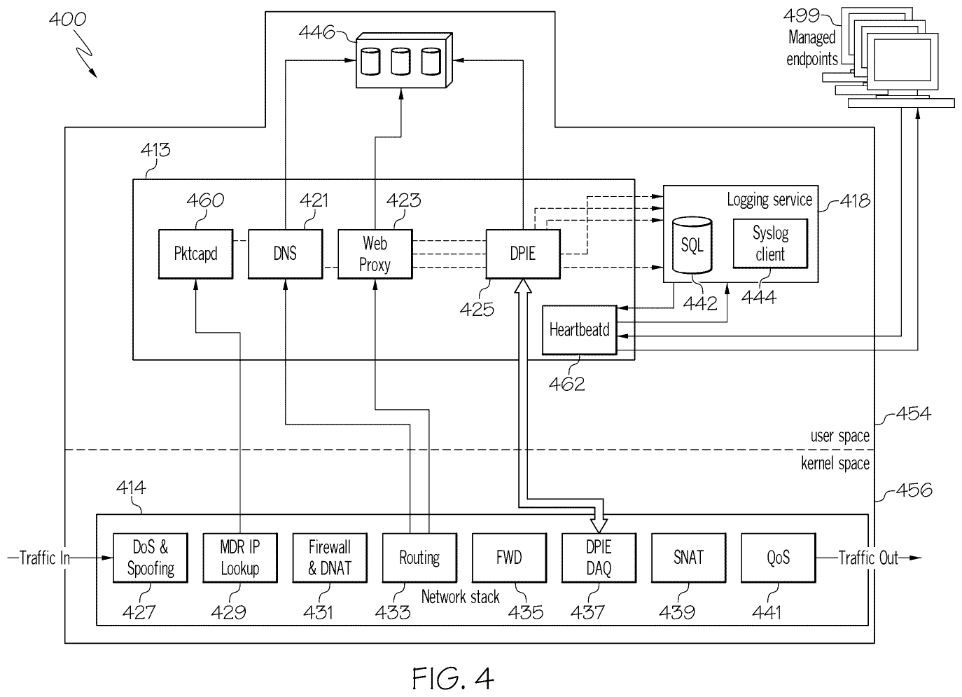

FIG. 4 depicts an architectural schematic view of a threat management computer system 400 including a firewall system 410 in communication with managed endpoints 499, according to an example embodiment. The architectural schematic view of a threat management computer system 400 may be the same or similar to the architectural schematic view of the threat management computer systems 200, 300 described hereinabove. Thus, while not shown, a central threat management system may be connected and/or otherwise in operable communication with an MDR system and/or analyst, which may be in operable communication with the firewall system 410.

However, unlike the threat management computer system 300 described hereinabove, the architectural schematic view of the threat management computer system 400 focuses on showing more specifics to a data plane 413 in a user space 454, rather than a control plane.

The data plane 413 includes a domain name system (DNS) service 421, a web proxy service 423 and a deep packet inspection engine (DPIE) service 425 and a packet inspection utility 460. Each of these services 421, 423, 425 may be configured to perform IOC lookups with the indicator of compromise database 446 associated with DNS traffic through the firewall system 410, web traffic through the firewall system 410, and DNS traffic inspected with DPIE through the firewall system 410. The data plane 413 further includes a heartbeat service 462 configured to provide for synchronized security and regularly check for updates in case the firewall system 410 is offline. The threat management computer system 400 may further include a logging service system 418 including an SQL database 442 and a syslog client 444 in communication with each of the heartbeat service 462 and the various services 421, 423, 425, 460.

In addition, the firewall system 410 includes a kernel space 456 through which traffic is input and output. The traffic is input into a network stack 414 within the kernel space 456. The network stack 414 includes several services or APIs including a denial of service (DoS) & spoofing service 427, an MDR internet protocol (IP) lookup service 429, a firewall and a destination network address translation (DNAT) service 431, a routing service 433, a port forwarding (FWD) service 435, a DPIE data acquisition service 437, a secure network address translation (SNAT) service 439 and a quality of service (QoS) service 441.

For performing an MDR lookup as contemplated herein in the previous embodiments, the firewall system performs the MDR lookup on IP type IOCs against source and destination IP addresses from IP header on all the network traffic arrives on the firewall system. The firewall module will also implement source/network based exceptions and tag UST bit that can be read by other user space applications for exceptions.

When endpoints are configured with external DNS server(s) and the firewall system is configured to submit external DNS server's traffic to a deep packet inspection engine (DPIE), the firewall module receives the traffic and performs MDR lookup on domain type IOCs against a DNS payload. Various configurations will submit DNS traffic to a DPIE, such as when an application classification is enabled, when a firewall rule is configured with identify and control applications (App control) or detect and prevent exploits (IPS).

When the firewall system is configured as a domain name system (DNS) server in endpoints, a contemplated DNS module receives the traffic and performs MDR lookup on IP and domain type IOCs against DNS payload.

A WebProxy module may further be configured to perform an MDR lookup on all three IP, domain and URL type IOCs against Web payload for traffic. Configurations that will submit web traffic to the WebProxy module may include when a firewall rule is configured with “Web filtering” with “Use web proxy instead of DPI engine” option selected, or when the firewall system is configured as “Direct proxy” in end points.

The DPIE WIS module performs MDR lookup on all three IP, domain and URL type IOCs against Web payload for traffic submitted to it. Configurations that will submit web traffic to the DPIE WIS module may include when an Application classification is enabled, or when a Firewall rule is configured with Identify and control applications (App control), Detect and prevent exploits (IPS), and/or when a firewall rule is configured with Web filtering with “Use web proxy instead of DPI engine” option not selected.

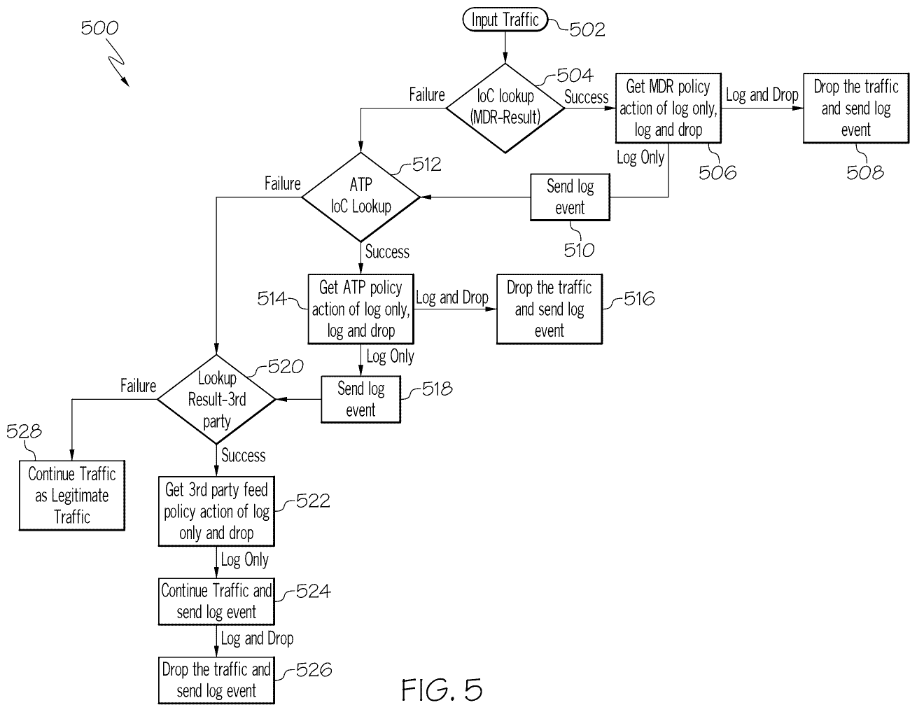

FIG. 5 depicts a flow chart 500 for performing a lookup by a consumer, according to an example embodiment. The flow chart 500 includes a first step 502 whereby traffic is input into a firewall system. At step 504, an IOC lookup is conducted for MDR-input IOCs provided by an MDR system. If this IOC lookup is successful, a step 506 includes getting an MDR policy action of “log only” or “log and drop.” If the policy action is “log and drop”, a step 508 of dropping the traffic and sending a log event. If the policy is to log only, a step 510 includes sending a log event.

If the IOC lookup fails or if the policy is to log only, the flow chart 500 includes a step 512 of performing an advanced threat protection (ATP) IOC lookup. If this ATP lookup is successful, a step 514 includes getting an ATP policy action of “log only” or “log and drop.” If the policy action is “log and drop”, a step 516 of dropping the traffic and sending a log event. If the policy is to log only, a step 518 includes sending a log event.

If the ATP lookup fails or if the policy is to log only, the flow chart 500 includes a step 520 of performing a third-party IOC lookup. If this third-party lookup is successful, a step 522 includes getting a third party policy action of “log only” or “log and drop.” If the policy action is “log only”, a step 524 of includes sending the log event and continuing the traffic. If the policy is to log and drop, a step 526 includes a step of dropping the traffic and sending the log event. If the third-party IOC lookup fails, the traffic is continued as legitimate traffic at a step 528.

How the contemplated MDR system and threat lookup should be performed by consumer will be described with reference to the figure. DNS, Web Proxy & DPIE services can lookup MDR IOC from shared memory initialized by the MDR engine and threat feed via aptp library. On receiving traffic, the system is configured to perform lookup on the MDR IOCs. If lookup is successful and the resultant action is log and drop, the system will drop the traffic and send the log event to a reporting daemon with resultant threat feed name in new log field “threat_feed” and resultant threat feed category in log field “threat”. If the lookup is successful and the resultant action is log only, the system will send the log event to a reporting daemon with resultant threat feed name in new log field “threat_feed” and resultant threat feed category in log field “threat” and perform lookup in the threat data (current behavior) with log line enhancement with new log field “threat_feed” set as “Sophos ATP”. If lookup is unsuccessful, the system will perform lookup in ATP (advanced threat protection) threat data (current behavior) with log line enhancement with new log field “threat_feed” set as “Sophos ATP”. If both Xstream MDR and ATP lookup are unsuccessful, the system will treat it as a legitimate traffic and continue the traffic journey.

The firewall service contemplated herein will use IPset and IPtables chains to perform lookup on the MDR system and ATP IP type IOCs. This may follow the same workflow as above. However, log events will be sent to pktcapd service which eventually sends log event to a reporting daemon. If Security heartbeat feature is enabled, a reporting daemon will request heartbeat service to retrieve additional information from endpoint. The heartbeat service will generate new log event with additional information received and sends it to a reporting daemon.

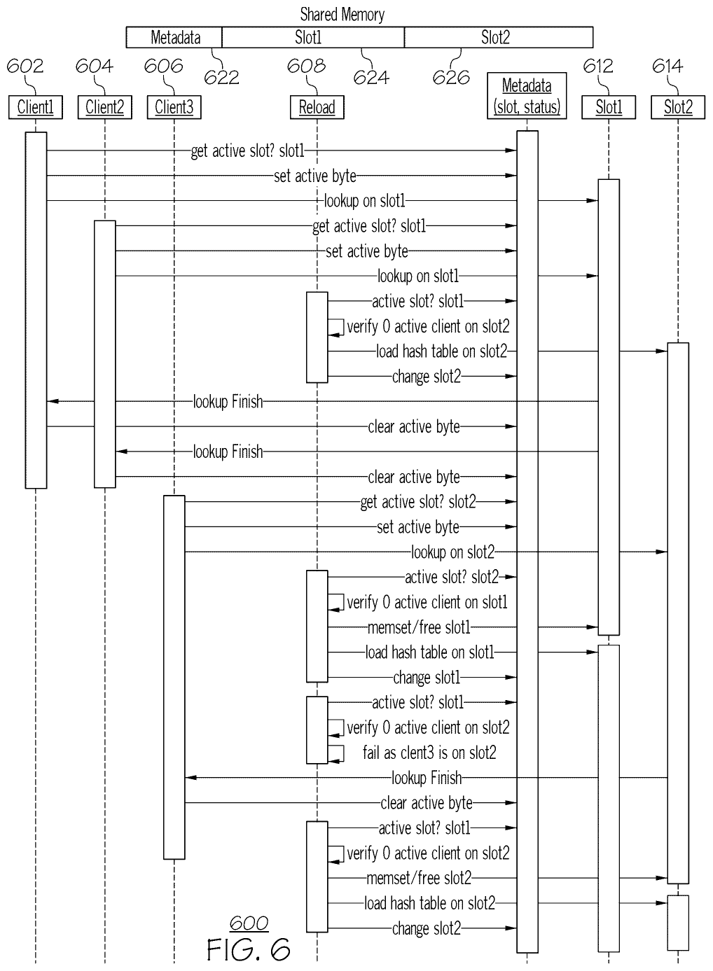

FIG. 6 depicts a sequence flow 600 for performing a lookup, according to an example embodiment. As shown, shared memory 620 includes metadata 622 with a plurality of slots, such as a first slot 624 and a second slot 626. The sequence flow 600 includes a flow related to a first client 602, a second client 604, a third client 606, a hash reload sequence 608, metadata 610 (i.e. the metadata 622 of the shared memory 620), Slot1 612 (i.e. the first slot 624 of the shared memory 620), and Slot2 614 (i.e. the second slot 626 of the shared memory 620).

One of the crucial and most important aspect is how fast MDR threat feeds can be looked up and when new feed arrives is how quickly it can be reconfigured.

The MDR Engine implementation includes key data structures and locking. A Glib hash table is used as a backbone and it is adapted for shared memory based hash table. Pointers are modified with offset values. Memory management calls such as malloc/calloc/free are wrapped to use new memory management calls to manage memory from pre-allocated shared memory. Shared memory may contain three slots. One Metadata slot contains active slot index and tracker for active clients. Two hash tables slots, where one of them will be active and another one will be used to prepare the new feed update in RCU style. The described system includes parallel lockless lookup on the hash table.

On create/startup a producer will load hash table in active slot (slot 1) and atomically set active slot index in metadata and the consumer will map this shared memory in read only mode. On update/reload, a producer will read the metadata and atomically check which slot is active and number of active clients on that slot. A new feed update will be loaded in non-active slot and readers' active slot index will be atomically switched to it. On lookup, lookup will atomically read active slot index and the system will set a bit atomically in tracker region followed by performing the IOC lookup and unset the tracker bit.

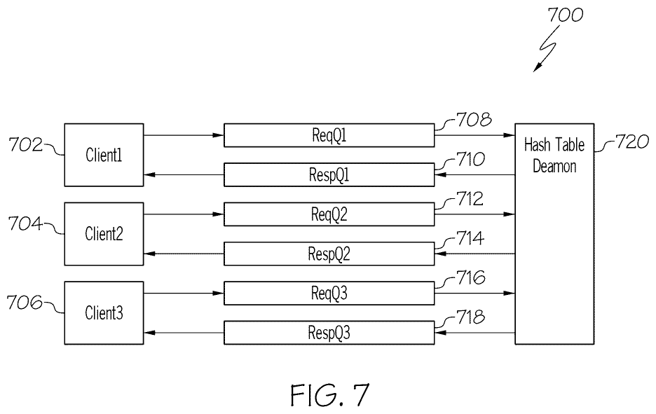

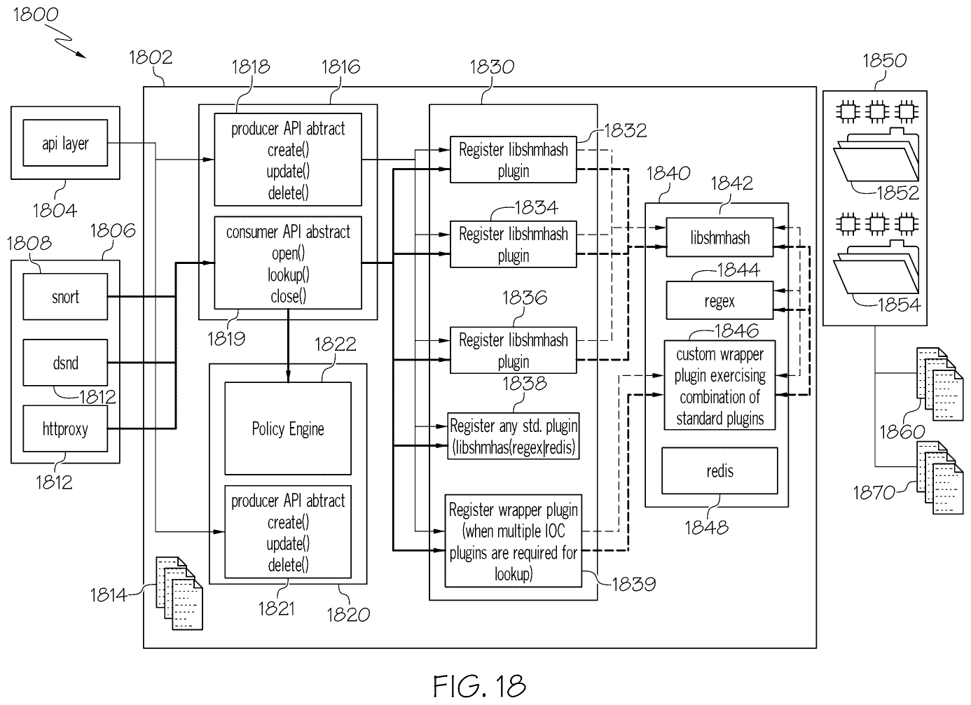

FIG. 7 depicts an alternative embodiment of a system 700 using a hash table Deamon 720 (rather than the risk storage system shown in FIG. 18), according to an example embodiment. The hash table Deamon 720 may be connected to a plurality of clients 702, 704, 706, and may communicate with a series of requests 708, 710, 716 and responses 710, 714, 718. In any embodiment, the MDR Engine can load shared memory on any virtual address. No fixed address is needed. For active readers tracking, metadata region of the shared memory is required to be writable in a consumer's address space. Consumers may be assumed to be trusted for this region.

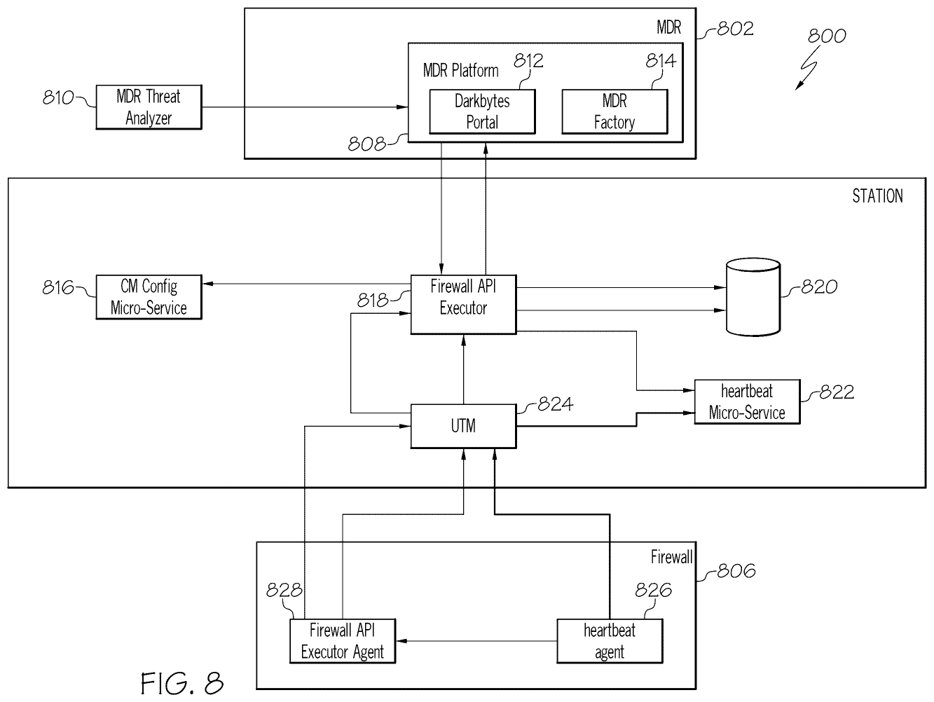

FIG. 8 depicts an architectural schematic view of a threat management computer system 800 having an MDR system 802 connected to a central threat management system 804 which is further connected to a firewall system 806, according to an example embodiment.

As shown, an MDR threat analyzer 810 or analyst may interact with the MDR system 802, which may be a software or application MDR platform 808 configured to monitor network traffic and identify threats using one or more of the MDR threat analyzers 810. The MDR platform 808 includes a unified endpoint protection platform portal 812 as well as an MDR factory 814. The MDR platform 808 is connected to the central threat management system 804 in order to send API requests to the central threat management system 804 with a secured service access (SSA), such as SSAv2.

The central threat management system 804 includes a firewall API executor 818 connected to a storage location 820 within which API storage configurations may be stored and API execution results may be updated. The threat management system 804 further includes a configuration microservice 816 for providing firewall details to the firewall API executor 818. Further, the central threat management system 804 includes a unified threat management system 824 connected to the firewall API executor 818 configured to provide API execution results and pull configurations for a firewall from a database. Still further, the central threat management system 804 includes a heartbeat micro-service 822 configured to provide for synchronized security and regularly check for updates in case the firewall system 806 is offline.

The firewall system 806 is shown including a firewall API executor agent 828 and a heartbeat agent 826. The heartbeat agent 826 may be in communication with the firewall API executor agent 828 for informing the firewall API executor agent 828 on firewall API requests. The firewall system 806 generally communications periodic heartbeat information and performs communications pursuant to API requests with the unified threat management system 824 of the central threat management system 804.

Embodiments of the MDR system described herein may enable an MDR analyst to update a threat feed object and get threat feed object details, add IOCs under a threat feed object, remove specific or all IOCs present under a threat feed object, be able to get specific IOCs present under a threat feed object, and poll execution results of asynchronous APIs using a job ID returned by a central threat management facility system. The MDR system described herein may allow an administrator of a central threat management facility system to view execution status' of APIs under a Task Queue page.

The MDR system described herein may use a secured service access (SSA) authentication mechanism to call a threat feed API from a central threat management facility system. The MDR system may able to read/update threat feed object using a REST API from the central threat management facility system. The MDR system may furhter be able to add/remove IOCs under threat feed object using the REST API from the central threat management facility system. The MDR system should be able to get specific IOCs configured under threat feed object using the REST API from the central threat management facility system. The central threat management facility system may include audit information in each API for firewall audit logging, and maintain executed REST API details of a previous predetermined period, such as the last 30 days.

According to various contemplated MDR to Central API request workflows, the MDR system may send a REST API request to a Firewall API Executor Micro-Service. This request can come from a Darkbytes portal or an MDR Factory. A Firewall API Executor Micro-Service does validation on payload sent by the MDR system. This validation may determine whether the firewall belongs to a correct tenantId which is passed in as a header. The Firewall API Executor generates unique job Id for API request. This job Id will be used to poll result of API execution. The Firewall API Executor generates opcode/configuration to be applied on the firewall system and stores details in its database. The configuration details may include a set of opcodes and metadata. This configuration data also includes audit-id for tracing back the request. Audit-id includes a principleId present in the SSA (e.g. SSAv2) token. The Firewall API Executor Informs a heartbeatd Micro-Service about new API request via Rest API call. The heartbeat service updates its redis cache with a new API request pending information of a firewall. The Firewall API Executor Sends Request accepted response to the MDR system. This response includes a API unique job id. During periodic (e.g., every 1-minute) heartbeat exchange between the firewall system and the heartbeat micro-service, the heartbeat micro-service informs a Firewall heartbeatd agent about any new APIs to be processed. The Heartbeatd agent running on firewall informs Firewall API Executor agent running on firewall about pending API requests. The Firewall API Executor agent fetches configuration from Firewall API executor micro-service for applying on the firewall. The Firewall API Executor agent executes the configuration on the firewall and sends a response to Firewall API executor micro-service with execution status. The Firewall API executor micro-service updates DB with execution status of API on the firewall sent by Firewall API Executor agent.

According to various contemplated MDR to Central API response workflows (which can be executed anytime after the previously described request workflow), the MDR Platform calls RESP API to Firewall API Executor Micro-Service for getting the execution result of a API Request associated with job id. The Firewall API Executor does validation of job id, customer and firewall. The Firewall API Executor queries its database for execution status of API request associated with the job id. The Firewall API Executor sends query result(query executed in step 3) to MDR system.

The central threat management facility system (Central) UI Admin workflow for Firewall execution status display includes the Central UI call Firewall API Executor Micro-Service API to get Firewall APIs execution status(Paginated Response. The Central UI displays Firewall API execution status in API TaskQueue page.

In various embodiments, a firewall system contemplated herein may be registered and managed by Central, the MDR system calls Central API using SSAv2 authentication, there is no hook given in Central UI to call these APIs, and the APIs involving firewall configuration changes may be asynchronous in nature.

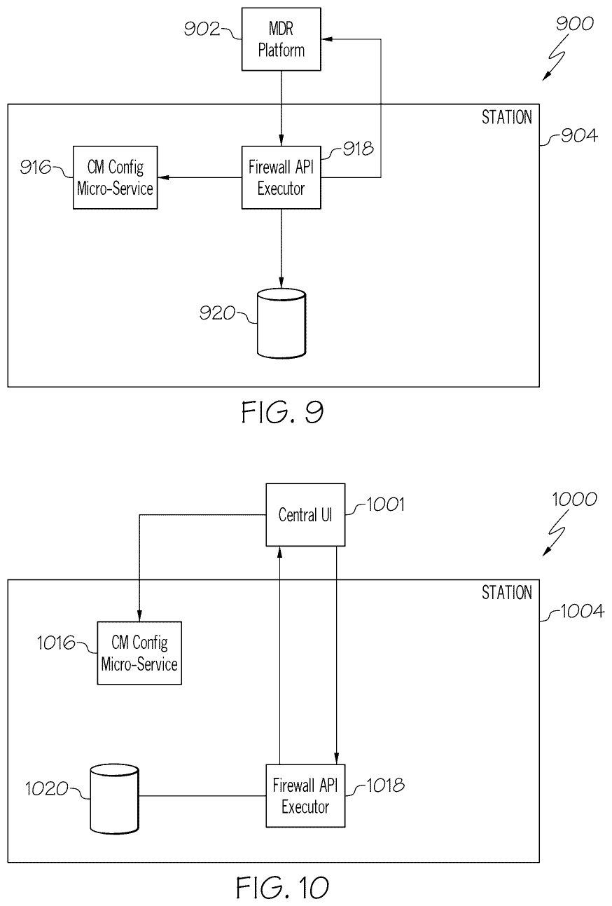

FIG. 9 depicts an architectural schematic view of a threat management computer system 900 having a central threat management system 904 such as the central threat management system 804 of FIG. 8 performing an API request execution, according to an example embodiment. The central threat management system 904 is connected to an MDR platform 902, such as the MDR platform 802, 808. The central threat management system 904 includes a firewall API executor 918 connected to a configuration microservice 916, such as the configuration microservice 816, and connected to a storage location 920, such as the storage location 820. The MDR platform 902 may be configured to poll the firewall API executor 918 using SSAv2, for example. The firewall API executor 918 may be configured to validate the firewall system with the configuration microservice 916, as well as get the API execution result from the storage location 920 in order for the firewall API executor 918 and the central threat management system 904 to return the API execution result to the MDR platform 902.

FIG. 10 depicts an architectural schematic view of a threat management computer system 1000 having a central threat management system 1004 such as the central threat management systems 804, 904 of FIGS. 8 and 9 receiving the results of the API request execution from a user interface, according to an example embodiment. The central threat management system 1004 is connected to a central UI 1001. The central threat management system 1004 includes a firewall API executor 1018 connected to a configuration microservice 1016, such as the configuration microservices 816, 916, and connected to a storage location 1020, such as the storage locations 820, 920. The central UI 1001 may be operable by a central administrator, and may be configured to request an API execution status from the firewall API executor 918. The firewall API executor 918 may be configured to retrieve this status from the storage location 920 in order for the firewall API executor 918 to return the status result to the central UI 1001. Further, the central UI 1001 may get firewall details to display thereon from the configuration microservice 1016.

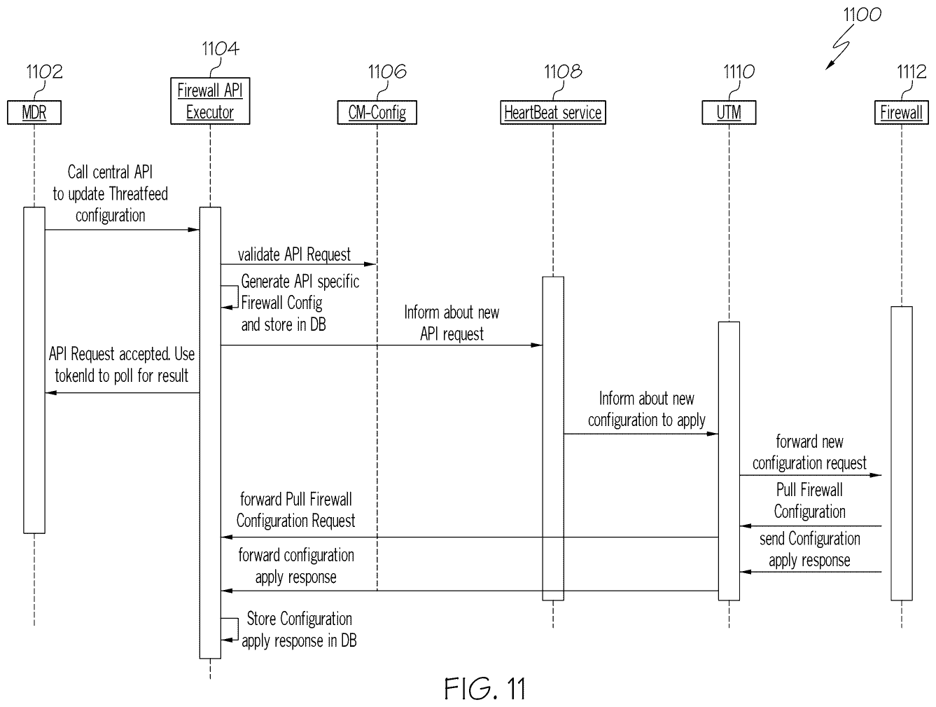

FIG. 11 depicts a sequence flow 1100 for performing an API request, according to an example embodiment. The sequence flow 1100 includes a sequence of events performed by an MDR system 1102, a firewall API executor 1104, a configuration microservice 1106, a heartbeat service 1108, a unified threat management system 1110, and a firewall system 1112. The MDR system 1102 may be configured to call a central API to update a threat feed configuration with the firewall API executor 1104. The firewall API executor 1104 may be configured to validate the API request with the configuration microservice 1106 and get API execution results from a database. The API executor 1104 may then inform the heartbeat service 1108 about the new API request and confirm that the API request is accepted with the MDR system 1102. The heartbeat service 1108 may be configured to inform the unified threat management system 1110 about a new configuration to apply. The unified threat management system 1110 may be configured to forward the new configuration request to the firewall system 1112. The firewall system 1112 may be configured to pull the firewall configuration from the unified threat management system 1110. The unified threat management system 1110 may be configured to forward the pull firewall configuration request to the firewall API executor 1104. The firewall system 1112 may then further send a configuration apply response to the unified threat management system 1110. The unified threat management system 1110 may then forward this configuration apply response to the firewall API executor 1104, which may then store the configuration apply response in a storage database.

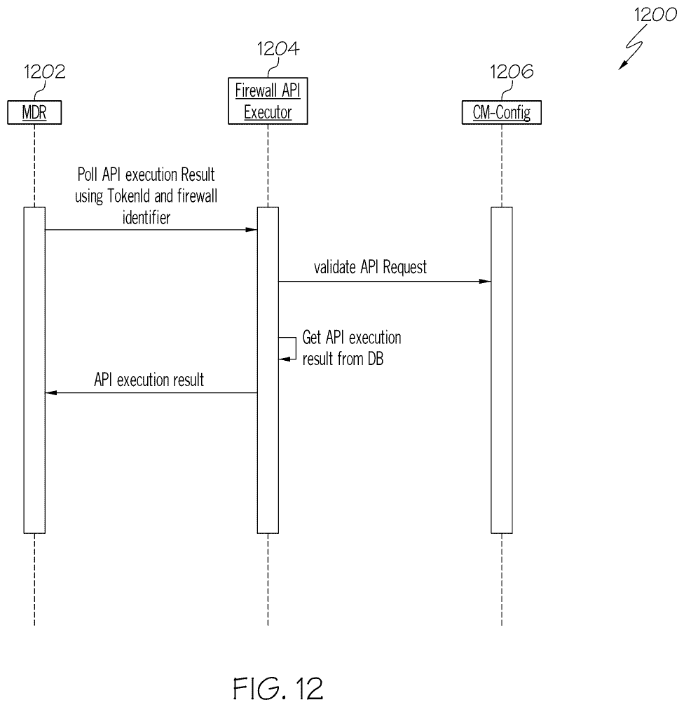

FIG. 12 depicts a sequence flow 1200 for performing receiving the results of the API request execution, according to an example embodiment. The sequence flow 1200 includes a sequence of events performed by an MDR system 1202, a firewall API executor 1204, and a configuration microservice 1206. As shown, the MDR system 1202 is configured to poll API execution results using a tokenID and firewall ID from the firewall API executor 1204. The firewall API executor 1204 may be configured to validate the API request with the configuration microservice 1206 and get API execution results from a database. The API executor 1204 may then return the API execution result to the MDR system 1202.

As described above, the APIs contemplated herein to push configurations to a firewall may be asynchronous in nature. The Firewall Configuration APIs supports threat-feeds object creation and its life cycle, managing IOCs under threat-feeds objects. A JSON based response may be provided by the firewall system in response to a transactionID request. In response to various requests such as an update MDR threat-feed request, a query MDR threat-feed request, a search indicators status request, a create MDR threat feed indicator request, a batch delete MDR threat feed indicator request, a unique token number to fetch the result of the request may be provided by the Firewall system. The central threat management facility system may convert each API call to corresponding opcodes which is understandable by the firewall system. For handling API requests, a new Micro-Service named Firewall API Executor may be provided within the firewall system. Autoscaling of this Micro-Service is done based on number of requests, memory and CPU usage. A number of instances of this Micro-Service may be always be running in the firewall system.

The above embodiments shown in FIGS. 2-12 provide methodology and systems for incorporating MDR and/or XDR information into actionable and automatic firewall responses to enable automatic threat responses by firewalls of monitored network systems. However, further embodiments contemplated provide for third party threat feed information to be processed and responded to automatically by firewalls of monitored network systems.

In some contemplated embodiments, methods, systems and/or computer program products for responding to threats include providing a threat management computer system configured to monitor a monitored network system; storing, by the threat management computer system, indicators of compromise directly known (i.e. without third party support or knowledge) to the central threat management computer system to an indicator of compromise database of the threat management computer system; adding third party indicators of compromise to the indicator of compromise database of the threat management computer system; governing automatic threat response of a firewall of the monitored network system using the indicator of compromise database of the threat management computer system; and automatically responding, by the firewall of the monitored network system, to threats associated with the third-party indicators of compromise.

In various embodiments, methods may include automatically responding, by the firewall of the monitored network system, to the indicators of compromise known to the threat management computer system. The indicator of compromise database may be a hash table library hosted by a threat management computer system in operable communication with the managed or extended detection and response system. Contemplated methods further include disabling the firewall from responding to threats associated with the third-party indicators of compromise. Moreover, contemplated methods include authenticating, by the threat management computer system, a username/password and/or API key associated with each third party associated with the third-party indicators of compromise.

Additionally or alternatively, methods may include defining, by the threat management computer system, an indicator of compromise as “log only” or “log and drop” for the threats associated with third party indicators of compromise, and automatically, by the firewall of the monitored network system, logging or logging and dropping traffic based on the defining.

In various embodiments, the automatically responding, by the firewall of the monitored network system, to threats associated with the third-party indicators of compromise further includes determining, by the firewall of the monitored network system, a malicious host associated with the third-party indicator of compromise, and automatically initiating, by the firewall of the monitored network system, an active threat response to automatically isolate the malicious host across the monitored network system. The determining, by the firewall of the monitored network system, the malicious host associated with the indicator of compromise further includes automatically performing, by the firewall, a third-party lookup with the indicator of compromise database based on an internet protocol (IP) address type indicator, a domain type indicator and/or URL type indicator against a web traffic payload, a DNS payload and/or a source or destination IP address. The automatically initiating, by the firewall of the monitored network system, the active threat response to automatically isolate the malicious host across the monitored network system may further include determining, by the firewall of the monitored network system, a policy action when the third-party lookup is positive, logging the event in an event log system or dropping the traffic and logging the event in the event log system based on the determining.

Further, the adding the third-party indicators of compromise to the indicator of compromise database of the threat management computer system may further include converting, by the threat management computer system, a format of the third-party indicators of compromise to a JavaScript Object Notation (JSON) format object.

In various embodiments, methods, systems and/or computer program products for responding to a threat include providing a threat management facility system configured to monitor a monitored network system, storing, by the threat management computer system, indicators of compromise known to the central threat management facility system to hash table library hosted by the threat management computer system in operable communication with the managed or extended detection and response system, adding third party indicators of compromise to the indicator of compromise database of the threat management computer system, governing automatic threat response of a firewall of the monitored network system using the indicator of compromise database of the threat management computer system; automatically performing, by the firewall, a third-party lookup with the indicator of compromise database based on an internet protocol (IP) address type indicator, a domain type indicator and/or URL type indicator against a web traffic payload, a DNS payload and/or a source or destination IP address; determining, by the firewall of the monitored network system, a malicious host associated with the third-party indicator of compromise; determining, by the firewall of the monitored network system, a policy action when the third-party lookup is positive; and logging the event in an event log system or dropping the traffic and logging the event in the event log system based on the determining.

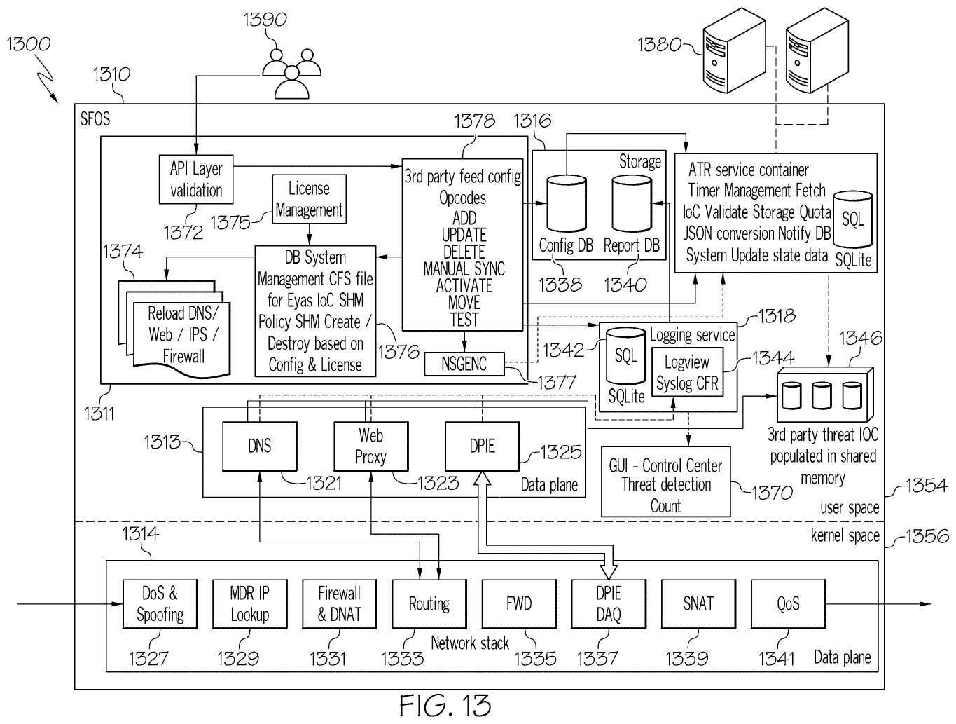

FIG. 13 an architectural schematic view of a threat management computer system 1300 having a firewall system 1310 connected to a central user interface (UI) 1390, according to an example embodiment. Embodiments described herein enable firewall administrators to configure 3rd party threat feed for IOCs, enable or disable each 3rd party threat feeds, set priority of each 3rd party threat feed, define traffic verdict as “monitor” (log only) or “block” (log and drop) for IOCs detected by 3rd party threat feeds, ability to add IP/Domain addresses as threat exceptions to avoid false positives and prevent unnecessary blocks, have visibility over IOCs identified by each 3rd party threat in the control center, Log viewer, and reports(local, central), and view IOCs on UI.

Embodiments described herein further enable administrators of a central threat management facility system (e.g., a cloud system) to configure 3rd party threat feed, enable or disable 3rd party threat feed, define traffic verdict as “monitor” (log only) or “block” (log and drop) for IOCs detected by 3rd party threat feed, and to add IP/Domain addresses as threat exceptions to avoid false positives and prevent unnecessary blocks.

Present embodiments contemplated herein recognize that clients and customers being managed by a central threat management facility system desire protection against IoC/threats identified by an external entity (3rd party threat feed) that is not directly associated with the central threat management facility system.

Embodiments described herein may support various forms of IOCs, including IPv4 addresses, Domains, URLs. Embodiments described herein include one IOC type supported per feed configuration. Further, IOC per line parsing may be supported. Systems may detect valid IOCs at the start of the line as per configured IOC type. Embodiments herein may ignore/reject an IOC which is not as per a configured IOC type.

Present embodiments contemplated herein recognize that clients and customers being managed by a central threat management facility system desire support for HTTPS protocol to fetch IOCs. Further clients and customers being managed by a central threat management facility system desire external entity authentication/authorization for accessing IOCs, including basic Authentication with username & password, and API key-based authorization.

Embodiments of third-party threat feed implementation described herein may allow such a threat feed to be enable/disabled from the firewall administrator or an administrator located at a central threat management facility system. Embodiments of third-party threat feed implementation described herein may separate policy action of “monitor” (log only) or “block” (log and drop) for each 3rd party threat feed, and may provide a count of detected threats by 3rd party feeds on a control center similar to the MDR system described above. Embodiments of third-party threat feed implementation described herein may provide event logging for threat detection by 3rd party feeds, and auto sync 3rd party IOC data based upon configured polling frequency. Embodiments of third-party threat feed implementation described herein may run in an isolated containerized environment with the least privileges.

Web Administrator users may be able to configure/add multiple threat-feed objects under the “Third Party threat feeds” tab. A threat feed priority may be managed & displayed based on action (block/monitor). The Web Administrator users may be able to perform enable/disable for each 3rd party feed, may be able to fetch IoC data immediately without waiting for periodic pull, may be able to update actions to Monitor or Monitor and drop for each 3rd party feed, and may be able to add threat exceptions, that will be applicable for Active threat response (ATR: MDR, Sophos X-Ops, Third Party). The Web Administrator may also jump to log viewer with the filter applied on the component as Active threat response.

As shown in FIG. 13, the firewall system 1310 includes a user space 1354 with at least two sections—1) a control plane 1311 which is configured to handle the configuration and update of the proposed third party based IOCs; and 2) a data plane 1313 which is configured to handle the IOC lookup for running traffic and apply action of “log only” or “log and drop.”

The control plane 1311 includes various components or services including an API layer validation 1372, third party feed configuration opcodes 1378 associated with various operations such as ADD, UPDATE, DELETE, MANUAL SYNC, ACTIVATE, MOVE, and TEST, external IOC database management 1376, DNS, Web, IPS and Firewall IOC configurations 1374, license management system 1375, and encryption/decryption system 1377. The IOC database management 1376 may include a compact file set (CFS) file, IOC shared memory files, Policy shared memory files, create and destroy systems based on configuration and/or licensing, and the like.

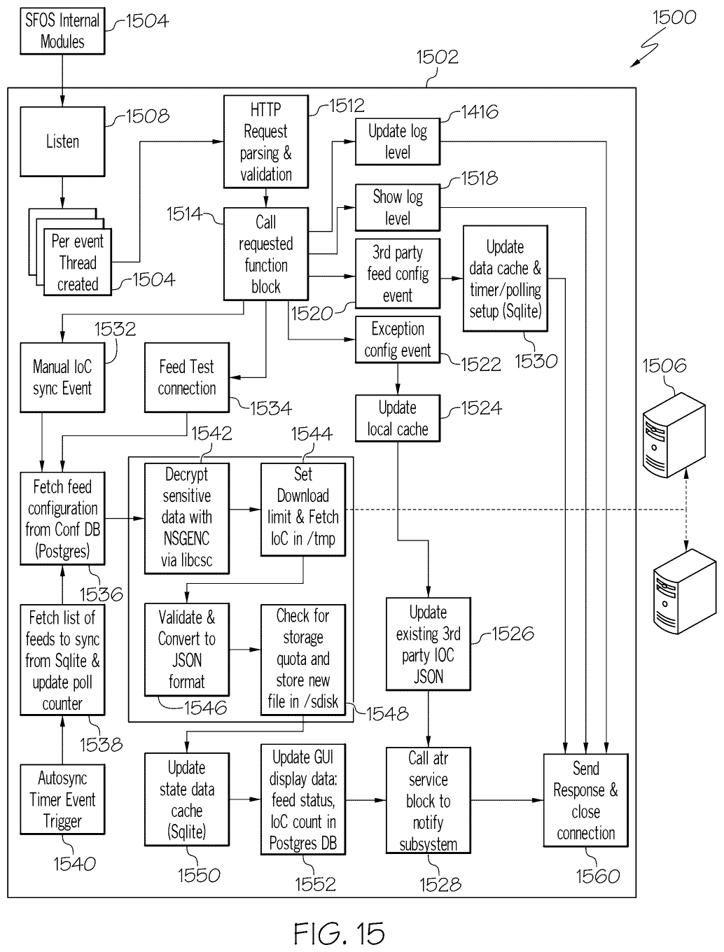

The control plane 1311 is shown in operable communication with an indicator of compromise database 1346 that includes MDR IOCs populated in a shared memory space which also communicates with the data plane 1313. The indicator of compromise database 1346 may be operated to an active threat response service container 1347 including an SQL database. The active threat response service container 1347 configure for timer management, fetching IOCs, validating storage quotas, JSON conversions, notifying external IOC storage databases, and updating the state of data. The active threat response service container 1347 may be connected to an external IOC storage database 1380 (described in detail herein below with respect to FIG. 15).

The data plane 1313 includes a domain name system (DNS) service 1321, a web proxy service 1323 and a deep packet inspection engine (DPIE) service 1325. Each of these services 1321, 1323, 1325 may be configured to perform IOC lookups with the indicator of compromise database 1346 associated with DNS traffic through the firewall system 1310, web traffic through the firewall system 1310, and DNS traffic inspected with DPIE through the firewall system 1310.

The threat management computer system 1300 further includes a storage system 1316 connected to the control plane 1311 including a configuration database 1338 and a report database 1340. The threat management computer system 1300 may further include a logging service system 1318 including an SQL database 1342 and a syslog client 1344. This logging service system 1318 may be in communication with the storage system 1316 and the data plane 1313, as well as a GUI control center system 1370.

In addition, the firewall system 1310 includes a kernel space 1356 through which traffic is input and output. The traffic is input into a network stack 1314 within the kernel space 1356. The network stack 1314 includes several services or APIs including a denial of service (DoS) & spoofing service 1327, an MDR internet protocol (IP) lookup service 1329, a firewall and a destination network address translation (DNAT) service 1331, a routing service 1333, a port forwarding (FWD) service 1335, a DPIE data acquisition service 1337, a secure network address translation (SNAT) service 1339 and a quality of service (QoS) service 1341.

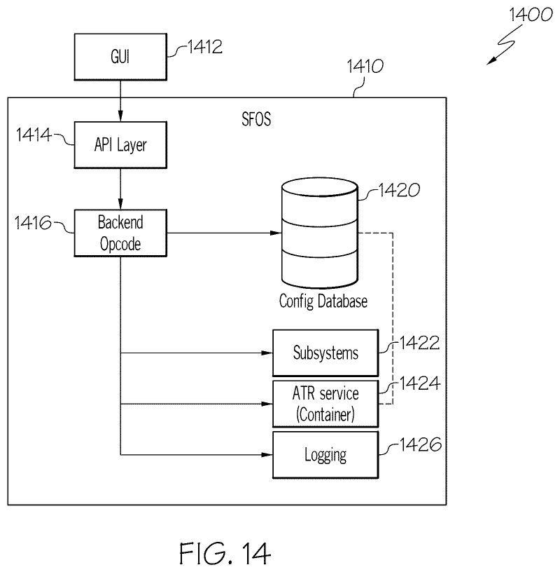

FIG. 14 depicts an architectural schematic view of a firewall system 1410 connected to a graphical user interface (GUI) 1412, according to an example embodiment. As shown, the firewall system 1410 may include an API layer 1414 operably connected to the GUI 1412. The API layer 1414 may further be connected to backend opcode 1416, which may be connected to a configuration database 1420. The backend opcode 1416 may further be connected to firewall and IOC storage subsystems 1422, active threat response containerized systems 1424, and logging systems 1426 (e.g., using Garner).

FIG. 15 depicts an architectural schematic view of a containerized service request processing flow for a firewall system 1502 connected to internal firewall modules 1504, according to an example embodiment. The internal firewall modules 1504 may make various REST requests to the firewall system 1502. For example, the firewall system 1502 may be configured to receive third party feed configuration change event requests, update log level requests, show current log level requests, third party feed test connection events, exception configuration change events, and manual synchronization of IOCs from a particular feed events. Various changes may be made according to a managed timer and/or a polling interval.

When a request is made to the firewall system 1502, such a request may be listened to at a step 1508 by a local host. A thread may be created at a step 1510, whereby HTTP request parsing and validation 1512 is conducted. A call request function block 1514 may update log levels 1516, show log levels 1518, perform a third-party feed configuration event 1520, perform an exception configuration event 1522, perform a manual IOC sync event 1532, or perform a feed test connection 1534, depending on the request being made.

In the event the third party feed configuration event 1520 request is made, the state data cache and timer/polling setup may be updated at a step 1530.

In the event that an exception configuration event request is made, the local cache is updated at a step 1524. Third party IOC JSONs are then updated at step 1526. Next, calling an active threat response service block to notify a subsystem may occur at a step 1528.

In the event that either the request is made to perform a manual IOC sync event 1532, or perform a feed test connection 1534, a feed configuration from a database may be fetched at a step 1536. This process may occur pursuant to an autosync timer event trigger 1540 which may fetch a list of feeds to sync from a database and update a poll counter at a step 1538. This data may be decrypted at a step 1542, then a download limit may be set and an IOC may be fetched at a step 1544 from an external connection to an external IOC database 1506 from third parties, then a validation and conversion to JSON format may occur at a step 1546, and a storage quota may be checked before storing a new file at a step 1548. Once the new file is stored, an update state data cache may be conducted at a step 1550, then a GUI display data may be updated, as well as feed status, IOC count and the like, at a step 1552. Similar to the exception process, calling an active threat response service block to notify a subsystem may next occur at the step 1528.

In all cases for requests, a final step 1560 may include sending a response by the firewall system 1502 and closing the connection.

Once the admin user configures/adds a new third-party feed from the firewall system UI or a UI associated with the central threat management facility system, the firewall system validates & stores configuration in configDB. This includes the firewall system generating a service ATR event for the new configuration, generating an event log for the new configuration, updating a polling frequency timer and/or fetching IoC's in the background.

The firewall system may thus be configured to start fetching IOCs from the third-party threat feed. This may further include downloading the IOC file, which may further include marking a feed status as failure in case of any error (like authentication, connectivity, etc) and comparing the SHA256 of the downloaded file with the previous SHA256 already stored in DB (if SHA256 matches and the feed status is successful then skip further processing). This may further include converting to JSON format which will be used by the lookup engine including comparing the SHA256 of the processed JSON file with the previous SHA256 already stored in DB (If SHA256 matches and the feed status is successful then skip further processing, and checking a storage quota. If the quota is full, the system may update the feed status & reject the new JSON file. In case of any internal error, the system may update the status accordingly. The system may thus store and generate JSON files, and notify consumers (Firewall, DNS, Web, IPS) of successful IOC updates, as well as reload the Lookup engine for updated IOCs.

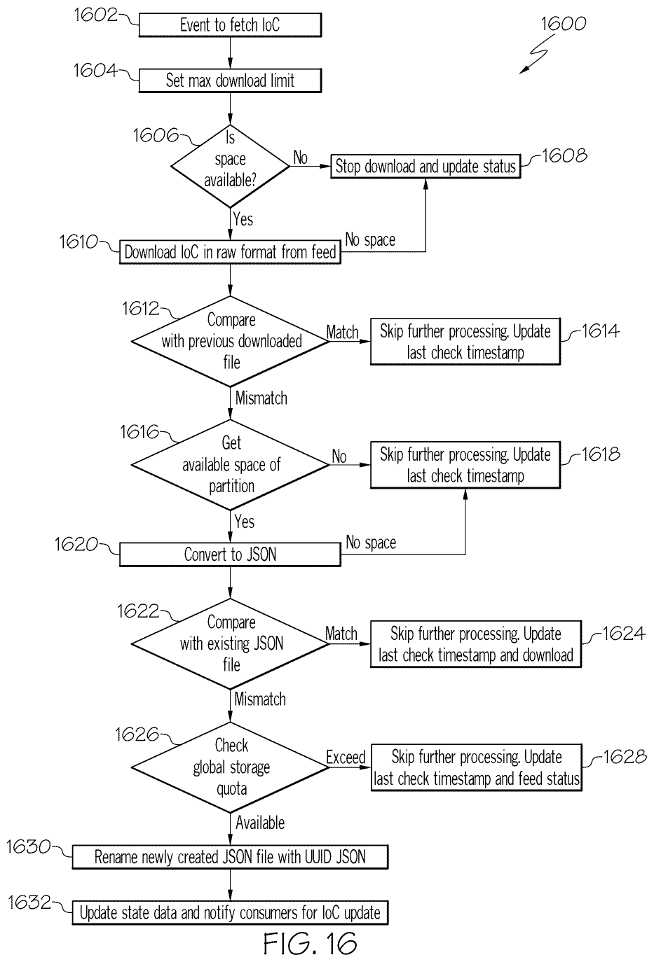

FIG. 16 depicts a flow chart 1600 for performing a third-party threat feed lookup by a consumer, according to an example embodiment. The threat lookup using thirty threat feeds may be the same or similar to the MDR system described above. This third-party threat lookup workflow may further be the same or similar to the MDR system described above. The third-party threat feed may use a risk storage system or library, such as the system shown in FIG. 18, to store third party threat information and convert this information into a usable format for lookup by the third party threat feed. Such a risk storage system or library may provide all data that needs to be used by consumer service and filter-out lookup detection based on priority. Firewall system priority management may be completed using Linked list data structure. Alternatively, Lexicographic rank may be used for priority management.

The flow chart 1600 or method includes a first step 1602 of receiving an event to fetch an IOC from a third party threat feed. The method 1600 includes a next step 1604 of setting a maximum download limit 1604 and a next step 1606 of determining if space is available. If space is not available, a step 1608 includes stopping downloading and updating the status. If space is available, a step 1610 includes downloading the IOC in a raw format from a third party threat feed. The step 1612 then includes comparing a hash function (e.g., SHA-256) with a previous downloaded file. If there is a match, a step 1614 may include skipping further processing and updating the last checked timestamp. If there is no match or a mismatch, the step 1616 may include getting available space of a partition. If there is no available space, a step 1618 may include skipping further processing and updating the last checked timestamp. If space is available, a step 1620 includes converting the IOC from the raw format to a JSON format. A next step 1622 includes comparing the hash function (e.g., SHA-256) with the JSON file. If a match occurs, the method 1600 includes a step 1624 of skipping further processing and updating the last checked timestamp and downloading the hash function (e.g., SHA-256). If a mismatch occurs, a step 1626 includes checking a global storage quota. If the quota is exceeded, a step 1628 includes skipping further processing and updating the last checked timestamp and feed status. If the quota is available, a step 1630 includes renaming the newly created JSON file with a UUID, and a step 1632 of updating the state data and notifying consumers for the IOC update.

The above embodiments shown in FIGS. 2-16 provide methodology and systems for incorporating MDR and/or XDR information into actionable and automatic firewall responses to enable automatic threat responses by firewalls of monitored network systems, as well as providing for third party threat feed information to be processed and responded to automatically by firewalls of monitored network systems. However, further embodiments contemplated may deploy machine learning models in order to analyze network traffic and make automatic artificial intelligence determinations as to the threat levels of such traffic based on the modeled analysis.

In some embodiments, methods, systems and/or computer program products for responding to a threat include receiving, by a threat management computer system from a firewall of a monitored network, transport layer security (TLS) traffic and/or domain name system (DNS) traffic metadata associated with network traffic received by firewall of the monitored network; analyzing, by the threat management computer system, the received TLS and/or DNS traffic metadata using a machine learning model hosted by the threat management computer system; returning, by the machine learning model of the threat management computer system, a threat score associated with the received TLS and/or DNS traffic metadata; and sending, by the threat management computer system, the threat score associated with the received TLS and/or DNS traffic metadata to the firewall of the monitored network.

In various other embodiments, methods may include sending, by the firewall of the monitored network using a secure batch application program interface, the TLS and/or DNS traffic metadata associated with network traffic received by firewall of the monitored network, wherein the metadata includes payload length information, destination IP information, and/or hostname sequence information; and automatically responding, by the firewall of the monitored network system, to the threat score associated with the received TLS and/or DNS traffic metadata to log and/or block a threat.

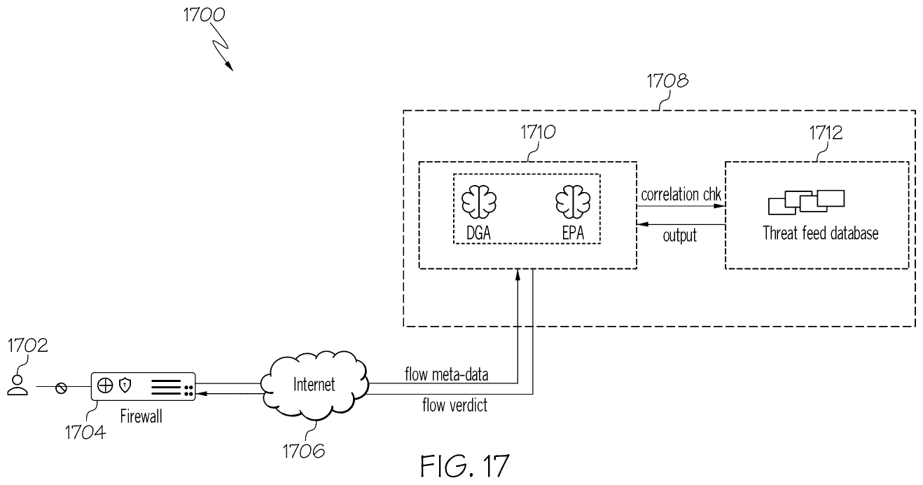

FIG. 17 depicts an architectural schematic view of a threat management computer system 1700 having a firewall system 1704 connected to a central threat management system 1708, according to an example embodiment. As shown, the firewall 1704 may be connected to one or more administrators 1702 of the firewall and/or a monitored network system. The firewall 1704 may be connected to the central threat management system 1708 over the internet 1706. Thus, the central threat management system 1708 may be a cloud based system. The firewall system 1704 may provide flow or traffic related metadata to the central threat management system 1708, and the central threat management system 1708 may be configured to return the firewall system 1704 with flow verdicts, as described herein. The central threat management system 1708 may include a machine learning hub 1710 having both a domain generated algorithm (DGA) and encrypted payload analytics (EPA) models. The machine learning hub 1710 may be in operable communication with a threat feed database system 1712. Contemplated herein are various local and cloud-based models for utilizing machine learning models.

For example, in various embodiments, a local NDR model may be deployed on a firewall system. Alternatively, Cloud based models are contemplated. For example, it is contemplated that a firewall system carves the meta-data from the flow of data to send to the NDR ML models running in the cloud securely via a batch API. This meta-data may contain flow information—such as payload lengths, destination-IP, hostname sequence, etc. This information is then processed by the NDR detection model in the cloud and returns a threat score with additional details like threat name, feeds it is present in, etc. Additionally, the DGA model may help in classifying the domains or domain categorization.

Various use cases are contemplated. The primary use case is to block threats and active adversaries. The firewall system may utilize the verdicts the EPA returned to prevent these threats. When NDR feeds are used with Sophos X-Ops and MDR, it significantly enhances the capability to block zero-day threats. Runing payload would give a prediction score (confidence %) & model index number (malware family e.g. cobalt strike). For example, an index number 0 may be benign (cannot map to any malware family), while a higher index number indicate a threat. The system may generate a percentage prediction score up to 100% which may provide an analyst with information to determine whether an action is appropriate. An NDR packet capture tool may be configured to extract what is required to accomplish such ML modeling and predictions.

The outcome from ML in the cloud will specify whether the scores are 1) EPA or DGA and 2) aggregate combined scoring from threat intel where possible. For example: EPA can result in a score of “susceptible” (e.g., 50%); But an aggregate scoring may provide a much more confident threat intelligence (e.g., 95%). Most parts EPA & DGA may be mutually exclusive, however, for some TLS flow—we may have both EPA and DGA.

Dragonfly may be the core data-generating program for the NDR sensor. It receives packets via promiscuous mode capture or tunneled packet reception. The meta information from the captured packet is extracted and transmitted to NDR models running in the cloud via batch API. NDR processes the flow information and returns the verdict to the firewall system.

As shown in FIG. 17, the ML model-based classification may add value when used in conjunction with external or additional list information (e.g. Sophos X-Ops threat feed database, as shown) in identifying malware call home for DNS and Web categorization that we use in the firewall. This can be used when Sophos X-Ops threat feed does not classify the domain and the DGA model can be used as a secondary lookup.

FIG. 18 depicts an architectural schematic view of a computer system 1800 including a risk information (e.g., IOC) storage system 1802 connected to producer 1804 and consumer systems 1806, according to an example embodiment. The consumer systems 1806 may include snort consumers 1806, dsnd consumers 1810, and httproxy consumers 1812. The computer system 1800 may be a threat storage system that is external to the various firewall systems described hereinabove, but which may communicate with the various centralized threat management systems, MDR or XDR systems, or the like, in order to store IOC threat information in a manner which can be accessed by the various APIs and/or firewall systems and/or threat management systems and the administrators thereof, as described herein above.

The risk storage system may be a local library stored within a central threat management facility system connectable to customers or client networks (e.g., a cloud based threat management system). The risk storage system may be a shared hash table system which can be plugged into a client or customer system. The risk storage system may be a policy engine which stores information related to which order to perform policy lookups. Further, the risk storage system may enable third party lookups and multi-threat feed support, as described herein.

The risk information storage system 1802 includes a core system 1816 having producer API interfaces 1818 and consumer API interfaces 1819. The core system 1816 may be operably connected to a policy core 1820 for policy lookup purposes. The policy core 1820 may include both a policy engine 1822 and producer API interfaces 1821 connected to a policy configuration JSON system 1814.

The core system 1816 interacts and communicates with a threat feed definitions system 1830. The threat feed definitions system 1830 includes a MDR threat feed register plugin 1832, a third party threat feed register plugin 1834, an advanced threat feed register plugin 1836, and future threat feed register plugins 1838, 1839.

The threat feed definitions system 1830 is connected to an IOC plugins system 1840 including, for example, a hash system plugin 1842, a regex system plugin 1844, a custom wrapper plugin 1846, and a Redis plugin 1848.

Overall, the risk information storage system 1802 may include settings and instructions filesystem 1850, including both consumer settings and instructions 1852, and producer settings and instructions 1854. This settings and instructions filesystem 1850 may also be operably connected to configuration related plugins 1860, and policy configurations 1870.

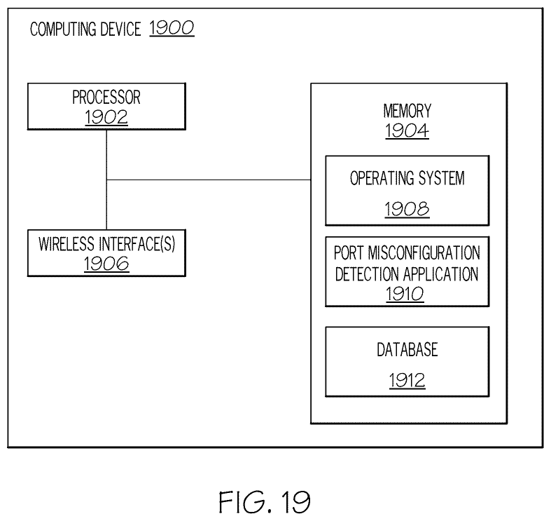

FIG. 19 is a diagram of an example computing device 1900, according to an example embodiment. As shown, the computing device 1900 includes one or more processors 1902, non-transitory computer readable medium or memory 1904, I/O interface devices 1906 (e.g., wireless communications, etc.) and a network interface 1908. The computer readable medium 1904 may include an operating system 1108, running one or more software applications 1910 in accordance with the systems and methods described herein.

In operation, the processor 1902 may execute the application 1910 stored in the computer readable medium 1904. The application 1910 may include software instructions that, when executed by the processor, cause the processor to perform operations for responding to a threat, as described and shown in the various Figures.

The application program 1910 may operate in conjunction with the data section 1912 and the operating system 1908. The device 1900 may communicate with other devices (e.g., a wireless access point) via the I/O interfaces 1906.

Although the foregoing figures illustrate various embodiments of the disclosed systems and methods, additional and/or alternative embodiments are contemplated as falling within the scope of this disclosure. For example, in one embodiment, this disclosure provides for a method for responding to a threat. The method includes identifying, by a managed or extended detection and response system, a threat associated with a monitored network system; sending, by the managed or extended detection and response system, threat information associated with the threat to a firewall of the monitored network system; and automatically responding, by the firewall of the monitored network system, to the sent threat information.

In another embodiment, the automatically responding, by the firewall of the monitored network system, includes responding without manual creation of address, domain, URL objects, web policies and/or firewall rules.

In a further embodiment, the sending, by the managed or extended detection and response system using the at least one application programing interface, the threat information associated with the threat to the firewall of the monitored network system further includes: sending, by the managed or extended detection and response system, the threat information associated with the threat to a central threat management facility system; receiving, by the central threat management facility system, the threat information associated with the threat from the managed or extended detection and response system; and pushing, by the central threat management facility system using an application programming interface (API), the threat information associated with the threat to a firewall of the monitored network system.

In yet another embodiment, the automatically responding, by the firewall of the monitored network system, to the sent threat information further includes determining, by the firewall of the monitored network system, a malicious host associated with an indicator of compromise; and automatically initiating, by the firewall of the monitored network system, an active threat response to automatically isolate malicious traffic coming from the malicious host across the monitored network system.

In yet a further embodiment, the determining, by the firewall of the monitored network system, the malicious host associated with the indicator of compromise further includes: automatically performing, by the firewall, a threat lookup with an indicator of compromise database based on an internet protocol (IP) address type indicator of compromise against source and/or destination IP addresses.

In another embodiment, the determining, by the firewall of the monitored network system, the malicious host associated with the indicator of compromise further includes automatically performing, by the firewall, a threat lookup with the indicator of compromise database based on an IP or domain type indicator of compromise against a DNS payload.

In a further embodiment, the automatically performing, by the firewall, the threat lookup with the indicator of compromise database based on the IP or domain type indicator of compromise against the DNS payload further includes: using a deep packet inspection engine and a DNS server to inspect the DNS payload; and automatically performing, by the firewall, a threat lookup with the indicator of compromise database based on the inspection of the DNS payload by the deep packet inspection engine and the DNS server.

In yet another embodiment, the determining, by the firewall of the monitored network system, the malicious host associated with the indicator of compromise further includes: automatically performing, by the firewall, a threat lookup with the indicator of compromise database based on an IP, domain and/or URL type indicator of compromise against a web traffic payload.

In a further embodiment, the automatically performing, by the firewall, the threat lookup with the indicator of compromise database based on the IP, domain and/or URL type indicator of compromise against the web traffic payload further includes: using the deep packet inspection engine to inspect the web traffic payload; and automatically performing, by the firewall, a threat lookup with the indicator of compromise database based on the inspection of the web traffic payload by the deep packet inspection engine.

In yet another embodiment, the automatically initiating, by the firewall of the monitored network system, the active threat response to automatically isolate the malicious host across the monitored network system further includes: determining, by the firewall of the monitored network system, a policy action when any of the threat lookups are positive; and logging the event in an event log system or dropping the traffic and logging the event in the event log system based on the determining.

In yet a further embodiment, the logging the event in an event log system or dropping the traffic and logging the event in the event log system based on the determining further includes: querying, by the firewall of the monitored network system, managed endpoints of the monitored network system for information including executable path, logged-in user, process user, process hash, endpoint UUID and/or process identifier.

In another embodiment, the indicator of compromise database is a shared memory hash table library.

In a further embodiment, the method includes using, by a heartbeat agent running on the firewall, a heartbeat microservice of the central threat management facility system for informing the firewall of pending API requests from the central threat management facility.

In yet another embodiment, the method includes converting, by the central threat management facility system, each API call to corresponding opcodes understandable by the firewall.

In yet a further embodiment, the converting further includes generating, by the central threat management facility system, a configuration to be applied on the firewall, wherein the configuration is pushed by the API.

In another embodiment, the method includes providing, by the central threat management facility system, a threat feed user interface that is displayed and to administrators of the monitored network; and enabling the administrators of the monitored network to provide an automatic response action to threats through the threat feed user interface so that the automatic responding, by the firewall of the monitored network system, to the sent threat information is conducted in accordance with the automatic response action.

In a further embodiment, the automatically responding, by the firewall of the monitored network system, to the sent threat information, further includes automatically initiating, by the firewall of the monitored network system, lateral movement protection based on the threat to ensure that a compromised host cannot move laterally or communicate outside the monitored network system.

In another embodiment, a threat management computer system includes one or more processors; one or more computer readable storage media; and computer readable code stored collectively in the one or more computer readable storage media, with the computer readable code including data and instructions to cause the one or more computer processors to perform a method for responding to a threat. The method includes identifying, by a managed or extended detection and response system of the threat management computer system, a threat associated with a monitored network system of the threat management computer system; sending directly or indirectly, by the managed or extended detection and response system, threat information associated with the threat to a firewall of the monitored network system; and automatically responding, by the firewall of the monitored network system, to the sent threat information.

In another embodiment, a computer program product includes one or more computer readable storage media having computer readable program code collectively stored on the one or more computer readable storage media, the computer readable program code being executed by one or more processors of a threat management computer system to cause the threat management computer system to perform a method for responding to a threat. The method includes identifying, by a managed or extended detection and response system, a threat associated with a monitored network system; sending directly or indirectly, by the managed or extended detection and response system, threat information associated with the threat to a firewall of the monitored network system; and automatically responding, by the firewall of the monitored network system, to the sent threat information.

In another embodiment, a method for responding to a threat includes identifying, by a managed or extended detection and response system, a threat associated with a monitored network system; sending, by the managed or extended detection and response system, threat information associated with the threat to a central threat management facility system; receiving, by the central threat management facility system, the threat information associated with the threat from the managed or extended detection and response system; pushing, by the central threat management facility system using an application programming interface (API), the threat information associated with the threat to a firewall of the monitored network system; determining, by the firewall of the monitored network system, a malicious host associated with an indicator of compromise including automatically performing, by the firewall, an MDR or XDR lookup with an indicator of compromise database based on an internet protocol (IP) address type indicator of compromise against source and/or destination IP addresses; and automatically initiating, by the firewall of the monitored network system, an active threat response to automatically isolate the malicious host across the monitored network system.

Accordingly, the foregoing systems and methods present technologically beneficial approach to addressing the problem of blocking a threatening endpoint or host across multiple various access points of a network. When a threat is detected, the present systems and methods recognize that time is of the essence. If an endpoint, such as a laptop computer, is threatening a monitored network system, this threat may be detected once by an MDR system and blocked across all access points, preventing the laptop from moving to another access point and connecting to the network (which would be allowed in the case that only the access point that the laptop is connected to is blocking the laptop). Thus, embodiments disclosed herein contemplate propagating a single command quickly across all network devices and access points to block one or more device identifiers or user identifications associated with a host or endpoint from those network devices and access points.

Furthermore, embodiments described herein allow for a single monitoring analyst, user or administrator to update a network configuration to block an endpoint globally across network devices of the monitored network system.

It will be appreciated that the modules, processes, systems, and sections described above may be implemented in hardware, hardware programmed by software, software instructions stored on a nontransitory computer readable medium or a combination of the above. A system as described above, for example, may include a processor configured to execute a sequence of programmed instructions stored on a nontransitory computer readable medium. For example, the processor may include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions may be compiled from source code instructions provided in accordance with a programming language such as Java, C, C++, C#.net, assembly or the like. The instructions may also comprise code and data objects provided in accordance with, for example, the Visual Basic™ language, or another structured or object-oriented programming language. The sequence of programmed instructions, or programmable logic device configuration software, and data associated therewith may be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections may be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above may be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein may be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that may be used on a variety of computer platforms. Alternatively, embodiments of the disclosed method, system, and computer program product may be implemented partially or fully in hardware using, for example, standard logic circuits or a VLSI design. Other hardware or software may be used to implement embodiments depending on the speed and/or efficiency requirements of the systems, the particular function, and/or particular software or hardware system, microprocessor, or microcomputer being utilized. Embodiments of the method, system, and computer program product may be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) may be implemented in software executed on a programmed general purpose computer, a special purpose computer, a microprocessor, a network server or switch, or the like.

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter. It should also be understood that references to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

1. A method for responding to a threat comprising:
identifying, by a managed or extended detection and response system, a threat associated with a monitored network system;
sending, by the managed or extended detection and response system, threat information associated with the threat to a firewall of the monitored network system; and
automatically responding, by the firewall of the monitored network system, to the sent threat information.

2. The method of claim 1, wherein the automatically responding, by the firewall of the monitored network system, includes responding without manual creation of address, domain, URL objects, web policies and/or firewall rules.

3. The method of claim 1, wherein the sending, by the managed or extended detection and response system using the at least one application programing interface, the threat information associated with the threat to the firewall of the monitored network system further comprises:
sending, by the managed or extended detection and response system, the threat information associated with the threat to a central threat management facility system;
receiving, by the central threat management facility system, the threat information associated with the threat from the managed or extended detection and response system; and
pushing, by the central threat management facility system using an application programming interface (API), the threat information associated with the threat to a firewall of the monitored network system.

4. The method of claim 1, wherein the automatically responding, by the firewall of the monitored network system, to the sent threat information further comprises:
determining, by the firewall of the monitored network system, a malicious host associated with an indicator of compromise; and
automatically initiating, by the firewall of the monitored network system, an active threat response to automatically isolate malicious traffic coming from the malicious host across the monitored network system.

5. The method of claim 4, wherein the determining, by the firewall of the monitored network system, the malicious host associated with the indicator of compromise further comprises:
automatically performing, by the firewall, a threat lookup with an indicator of compromise database based on an internet protocol (IP) address type indicator of compromise against source and/or destination IP addresses.

6. The method of claim 4, wherein the determining, by the firewall of the monitored network system, the malicious host associated with the indicator of compromise further comprises:
automatically performing, by the firewall, a threat lookup with the indicator of compromise database based on an IP or domain type indicator of compromise against a DNS payload.

7. The method of claim 6, wherein the automatically performing, by the firewall, the threat lookup with the indicator of compromise database based on the IP or domain type indicator of compromise against the DNS payload further comprises:
using a deep packet inspection engine and a DNS server to inspect the DNS payload; and
automatically performing, by the firewall, a threat lookup with the indicator of compromise database based on the inspection of the DNS payload by the deep packet inspection engine and the DNS server.

8. The method of claim 4, wherein the determining, by the firewall of the monitored network system, the malicious host associated with the indicator of compromise further comprises:
automatically performing, by the firewall, a threat lookup with the indicator of compromise database based on an IP, domain and/or URL type indicator of compromise against a web traffic payload.

9. The method of claim 8, wherein the automatically performing, by the firewall, the threat lookup with the indicator of compromise database based on the IP, domain and/or URL type indicator of compromise against the web traffic payload further comprises:
using the deep packet inspection engine to inspect the web traffic payload; and
automatically performing, by the firewall, a threat lookup with the indicator of compromise database based on the inspection of the web traffic payload by the deep packet inspection engine.

10. The method of claim 4, wherein the automatically initiating, by the firewall of the monitored network system, the active threat response to automatically isolate the malicious host across the monitored network system further comprises:
determining, by the firewall of the monitored network system, a policy action when any of the threat lookups are positive; and
logging the event in an event log system or dropping the traffic and logging the event in the event log system based on the determining.

11. The method of claim 10, wherein the logging the event in an event log system or dropping the traffic and logging the event in the event log system based on the determining further comprises:
querying, by the firewall of the monitored network system, managed endpoints of the monitored network system for information including executable path, logged-in user, process user, process hash, endpoint UUID and/or process identifier.

12. The method of claim 4, wherein the indicator of compromise database is a shared memory hash table library.

13. The method of claim 3, further comprising:
using, by a central management heartbeat agent running on the firewall, a heartbeat microservice of the central threat management facility system for informing the firewall of pending API requests and pulling the pending API requests from the central threat management facility.

14. The method of claim 3, further comprising:
converting, by the central threat management facility system, each API call to corresponding opcodes understandable by the firewall.

15. The method of claim 13, wherein the converting further comprises:
generating, by the central threat management facility system, a configuration to be applied on the firewall, wherein the configuration is pushed by the API.

16. The method of claim 3, further comprising:
providing, by the central threat management facility system, a threat feed user interface that is displayed and to administrators of the monitored network; and
enabling the administrators of the monitored network to provide an automatic response action to threats so that the automatic responding, by the firewall of the monitored network system, to the sent threat information is conducted in accordance with the automatic response action.

17. The method of claim 1, wherein the automatically responding, by the firewall of the monitored network system, to the sent threat information, further comprises:
automatically initiating, by the firewall of the monitored network system, lateral movement protection based on the threat to ensure that a compromised host cannot move laterally or communicate outside the monitored network system.

18. A threat management computer system, comprising:
one or more processors;
one or more computer readable storage media; and
computer readable code stored collectively in the one or more computer readable storage media, with the computer readable code including data and instructions to cause the one or more computer processors to perform a method for responding to a threat comprising:
identifying, by a managed or extended detection and response system of the threat management computer system, a threat associated with a monitored network system of the threat management computer system;
sending directly or indirectly, by the managed or extended detection and response system, threat information associated with the threat to a firewall of the monitored network system; and
automatically responding, by the firewall of the monitored network system, to the sent threat information.

19. A computer program product comprising:
one or more computer readable storage media having computer readable program code collectively stored on the one or more computer readable storage media, the computer readable program code being executed by one or more processors of a threat management computer system to cause the threat management computer system to perform a method for responding to a threat comprising:
identifying, by a managed or extended detection and response system, a threat associated with a monitored network system;
sending directly or indirectly, by the managed or extended detection and response system, threat information associated with the threat to a firewall of the monitored network system; and
automatically responding, by the firewall of the monitored network system, to the sent threat information.

20. A method for responding to a threat comprising:
identifying, by a managed or extended detection and response system, a threat associated with a monitored network system;
sending, by the managed or extended detection and response system, threat information associated with the threat to a central threat management facility system;
receiving, by the central threat management facility system, the threat information associated with the threat from the managed or extended detection and response system;
pushing, by the central threat management facility system using an application programming interface (API), the threat information associated with the threat to a firewall of the monitored network system;
determining, by the firewall of the monitored network system, a malicious host associated with an indicator of compromise including automatically performing, by the firewall, a threat lookup with an indicator of compromise database; and
automatically initiating, by the firewall of the monitored network system, an active threat response to automatically isolate the malicious host across the monitored network system.
